(19) United States
(12) Patent Application Publication
(10) Pub. No.: US 2015/0332021 A1
(43) Pub. Date: Nov. 19, 2015

(54) Guided Patient Interview and Health Management Systems

(71) Applicant: ThoroughCare, Inc., Spartanburg, SC (US)

(72) Inventor: Daniel S. Godla, Spartanburg, SC (US)

(73) Assignee: ThoroughCare, Inc., Spartanburg, SC (US)

(21) Appl. No.: 14/712,385

(22) Filed: May 14, 2015

Related U.S. Application Data
(60) Provisional application No. 61/994,086, filed on May 15, 2014.

(51) Int. Cl. G06F 19/00

(52) U.S. Cl. CPC G06F 19/36; G06F 19/322

(57) ABSTRACT

The present invention provides systems, methods, and devices for assessing a patient for medical information, and preparing and sharing a report thereof via a networked environment, such as the Internet. In some embodiments, the questions asked of a patient are uniquely tailored to avoid irrelevant questions and to explore relevant information more deeply than one-size-fits-all medical forms. Further embodiments relate to the analysis of answers provided, and the assignment of risk scores, the calculation of risk stratifications, and the identification of triggers prompting action on behalf of the patient, to be included in the report.

### RELATED APPLICATIONS

This application claims benefit under 35 U.S.C. §119(e) of U.S. Provisional Application No. 61/994,086 entitled, “GUIDED PATIENT INTERVIEW AND HEALTH MANAGEMENT SYSTEMS” filed on May 15, 2014, which provisional application is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

This invention relates to systems, methods, and devices for assessing a patient for medical information and preparing a report thereof via a networked environment, such as the Internet.

### BACKGROUND OF THE INVENTION

Doctors' offices, insurance companies, hospitals, clinics, and others have been subjecting patients to forms and questionnaires for generations. Those forms and questionnaires followed a set format initially created for relative ease of duplication, so that unique documents were not needed for each patient. However, patients are unique individuals. Numerous questions on each of those forms and questionnaires did not apply to each patient; and for many patients, the relevant questions did not delve deeply into the specific symptoms, conditions, and diseases that brought the patient to seek medical care in the first place.

The introduction of computer technology to the patient intake process facilitated the duplication, storage, and distribution of medical forms and information. Unfortunately, the same one-size-fits-all approach remains the overarching paradigm for electronic medical forms designed to collect the patient's information. The patient still must struggle through irrelevant questions, and healthcare professionals must wait until a face-to face appointment to pose specific in-depth questions to the patient about the most pressing medical complaint. Critical information gets missed because the right questions are not asked, risking misdiagnosis, delaying treatment, and lengthening the medical endeavor with inefficiency. Better tools for assessing a patient's medical information are needed.

### SUMMARY OF THE INVENTION

Unexpectedly, Applicant has invented new systems, methods, and devices to improve and expand the assessment of a patient's medical information. In some embodiments of the present invention, the patient is asked to address only the most relevant questions. When answers to those questions identify medical risk, follow-up questions are selected and presented in real time to immediately seek the most critical information needed for accurate medical diagnosis and treatment. Certain embodiments of the present invention facilitate that assessment no matter the location of the patient, the healthcare facilitator, the healthcare professional, or third-party vendors such as medical laboratories that may be called into assist with the diagnosis and treatment of the patient.

Some embodiments of the present invention relate to systems, devices, and methods for assessing a patient for medical information and preparing a report thereof via the Internet, one such method comprising:

A. Accessing, on a computer system operated by a healthcare facilitator, a record for the patient;
B. Preparing a unique website interface for the patient;
C. Preparing a list of questions for the patient, and providing the list of questions to the unique website interface;
D. Communicating a link to the unique website interface to the patient;
E. Receiving from the patient electronic input answering questions from the list of questions;
F. Electronically choosing and presenting follow-up questions on the unique website interface;
G. Receiving from the patient electronic input providing follow-up answers to the follow-up questions;
H. Electronically assigning one or more risk scores to one or more of the answers and one or more of the follow-up answers;
I. Electronically assigning one or more risk stratifications for one or more health conditions based on the sum of two or more of the risk scores;
J. Electronically identifying one or more triggers from the record, the answers, and the follow-up answers;
K. Electronically preparing a report of the one or more risk stratifications and the one or more triggers;
L. Electronically updating the record with the answers, follow-up answers, and the report; and
M. Electronically sending the report to the healthcare facilitator, optionally the patient, and optionally one or more additional healthcare professionals.

For example, some embodiments relate to computer systems comprising a processor and memory, the processor operable to execute program code stored in the memory, the program code adapted to cause the processor to

A. Access, in the memory, a record for the patient;
B. Prepare a unique website interface for the patient;
C. Prepare a list of questions for the patient, and provide the list of questions to the unique website interface;
D. Communicate a link to the unique website interface to the patient;
E. Receive from the patient electronic input answering questions from the list of questions;
F. Choose and present follow-up questions on the unique website interface;
G. Receive from the patient electronic input providing follow-up answers to the follow-up questions;
H. Assign one or more risk scores to one or more of the answers and one or more of the follow-up answers;
I. Assign one or more risk stratifications for one or more health conditions based on the sum of two or more of the risk scores;
J. Identify one or more triggers from the record, the answers, and the follow-up answers;
K. Prepare a report of the one or more risk stratifications and the one or more triggers;
L. Update the record with the answers, follow-up answers, and the report, and store the report in the memory; and
M. Alert a healthcare facilitator that the report has been prepared.

Further embodiments of the present invention relate to non-transitory computer readable storage medium comprising program code adapted to cause a computer system to:

A. Access, in the computer system, a record for the patient;
B. Prepare a unique website interface for the patient;
C. Prepare a list of questions for the patient, and provide the list of questions to the unique website interface;
D. Communicate a link to the unique website interface to the patient;
E. Receive from the patient electronic input answering questions from the list of questions;
F. Choose and present follow-up questions on the unique website interface;
G. Receive from the patient electronic input providing follow-up answers to the follow-up questions;
H. Assign one or more risk scores to one or more of the answers and one or more of the follow-up answers;
I. Assign one or more risk stratifications for one or more health conditions based on the sum of two or more of the risk scores;
J. Identify one or more triggers from the record, the answers, and the follow-up answers;
K. Prepare a report of the one or more risk stratifications and the one or more triggers;
L. Update the record with the answers, follow-up answers, and the report, and store the report in the computer system; and
M. Alert a healthcare facilitator that the report has been prepared.

Yet other embodiments relate to systems, devices, and methods for assisting a healthcare professional to assess a patient for medical information and prepare a report thereof via the Internet, one such method comprising:

A. Accessing via the internet, from a computer system operated by the healthcare professional, a unique website interface for the patient;
B. Receiving a list of questions for the patient on the unique website interface;
C. Accepting inputs on the computer system providing answers to questions from the list of questions;
D. Receiving follow-up questions for the patient on the unique website interface, the follow-up questions being based on the answers;
E. Accepting inputs on the computer system providing follow-up answers to the follow-up questions;
F. Receiving on the computer system a report of one or more risk stratifications and one or more triggers for the patient, wherein the one or more risk stratifications are based on summing one or more risk scores assigned to one or more of the answers, one or more of the follow-up answers, or a combination thereof;
wherein the one or more triggers have been identified from an electronic analysis of the record, the answers, and the follow-up answers.

Additional embodiments relate to computer systems comprising a processor and memory, the processor operable to execute program code stored in the memory, the program code adapted to cause the processor to

A. Access via the internet a unique website interface for the patient;
B. Receive a list of questions for the patient on the unique website interface;
C. Display questions from the list of questions on a visual display of the computer system;
D. Accept inputs on the computer system providing answers to questions from the list of questions, and provide the answers to the unique website interface;
E. Receive follow-up questions for the patient on the unique website interface, the follow-up questions being based on the answers;
F. Accept inputs on the computer system providing follow-up answers to the follow-up questions, and provide the follow-up answers to the unique website interface;
G. Receive on the computer system a report from the unique website interface of one or more risk stratifications and one or more triggers for the patient, wherein the one or more risk stratifications are based on summing one or more risk scores assigned to one or more of the answers, one or more of the follow-up answers, or a combination thereof;
wherein the one or more triggers have been identified from an electronic analysis of the record, the answers, and the follow-up answers.

Still additional embodiments relate to non-transitory computer readable storage media comprising program code adapted to cause a computer system to:

A. Access via the internet a unique website interface for the patient;
B. Receive a list of questions for the patient on the unique website interface;
C. Display questions from the list of questions on a visual display of the computer system;
D. Accept inputs on the computer system providing answers to questions from the list of questions, and provide the answers to the unique website interface;
E. Receive follow-up questions for the patient on the unique website interface, the follow-up questions being based on the answers;
F. Accept inputs on the computer system providing follow-up answers to the follow-up questions, and provide the follow-up answers to the unique website interface;
G. Receive on the computer system a report from the unique website interface of one or more risk stratifications and one or more triggers for the patient, wherein the one or more risk stratifications are based on summing one or more risk scores assigned to one or more of the answers, one or more of the follow-up answers, or a combination thereof;
wherein the one or more triggers have been identified from an electronic analysis of the record, the answers, and the follow-up answers.

In another aspect, the present invention relates to systems, devices, and methods for assisting a patient to provide medical information a report thereon via the Internet, one such method comprising:

A. Receiving a signal via the internet, on a computer system operated by a healthcare facilitator, a request from a computer system operated by the patient, seeking access to a unique website interface for the patient;
B. Presenting, by the computer system operated by the healthcare facilitator, a list of questions for the patient on the unique website interface;
C. Receiving, on the computer system operated by the healthcare facilitator, signals from the computer system operated by the patient, representing answers to questions from the list of questions;
D. Presenting, by the computer system operated by the healthcare facilitator, follow-up questions for the patient on the unique website interface, the follow-up questions being based on the answers;
E. Receiving, on the computer system operated by the healthcare facilitator, signals from the computer system operated by the patient, representing follow-up answers to the follow-up questions;
F. Preparing on the computer system operated by the healthcare facilitator, a report of one or more risk stratifications and one or more triggers for the patient,
wherein the one or more risk stratifications are based on summing one or more risk scores assigned to one or more of the answers, one or more of the follow-up answers, or a combination thereof;
wherein the one or more triggers have been identified from an electronic analysis of the record, the answers, and the follow-up answers.

Still further embodiments of the present invention relate to systems, devices, and methods for assessing a patient for medical information and preparing a report thereof via the Internet, one such method comprising:

A. Accessing, on a computer system operated by a healthcare facilitator, a record for the patient;
B. Preparing a unique website interface for the patient;
C. Preparing a list of questions for the patient, and providing the list of questions to the unique website interface;
D. Communicating a link to the unique website interface to the patient;
E. Receiving from the patient electronic input answering questions from the list of questions;
F. Electronically choosing and presenting follow-up questions on the unique website interface;
G. Receiving from the patient electronic input providing follow-up answers to the follow-up questions;
H. Electronically assigning one or more risk scores to one or more of the answers and one or more of the follow-up answers;
I. Electronically assigning one or more risk stratifications for one or more health conditions based on the sum of two or more of the risk scores;
J. Electronically identifying one or more triggers from the record, the answers, and the follow-up answers;
K. Electronically preparing a report of the one or more risk stratifications and the one or more triggers;
L. Electronically updating the record with the answers, follow-up answers, and the report; and
M. Electronically storing the report in an Internet-accessible location for access by the healthcare facilitator, optionally the patient, and optionally one or more additional healthcare professionals.

While the disclosure provides certain specific embodiments, the invention is not limited to those embodiments. A person of ordinary skill will appreciate from the description herein that modifications can be made to the described embodiments and therefore that the specification is broader in scope than the described embodiments. All examples are therefore non-limiting.

### BRIEF DESCRIPTION OF THE DRAWINGS

FIG. 1 schematically depicts one embodiment of the invention comprising a computer system 100 useful for storing, assessing, and analyzing patient information.

FIG. 2 schematically depicts another embodiment in which a patient's computer system 270 accesses a unique website interface 212 to provide health-related information.

FIG. 3 schematically depicts an embodiment in which a healthcare professional's computer system 380 accesses a unique website interface 312 to assess the health-related information of a patient 372.

FIG. 4 schematically depicts an embodiment in which a patient uses a computer system 470 to initiate healthcare by accessing a healthcare professional's website 484, which contains a link to a unique website interface 412 that provides a health information assessment tool.

FIG. 5 schematically depicts an embodiment in which a healthcare facilitator's computer system 500 is used to assist a patient 572 to use a health information assessment tool.

FIG. 6 provides a flowchart illustrating a method of assessing a patient for medical information and preparing a report thereof.

FIG. 7 provides an exemplary screen shot illustrating the design of a list of questions, in one embodiment of the invention.

FIG. 8 provides an exemplary screenshot illustrating an embodiment of the invention wherein a healthcare facilitator or healthcare professional chooses which sections from a list of questions will be presented to a patient on a unique website interface.

FIG. 9 provides an exemplary screenshot illustrating the design of an email message that will be sent to a patient to invite the patient to access a unique website interface.

FIG. 10 provides an exemplary e-mail message communicating a link to a unique website interface to the patient.

FIG. 11 provides an exemplary screenshot illustrating a healthcare facilitator or healthcare professional answering a question in a list of questions for the specific patient.

FIG. 12 provides an exemplary screenshot illustrating a patient answering a question in a list of questions for the specific patient.

FIG. 13 provides an exemplary screenshot illustrating a tablet-based environment for a patient answering a question in a list of questions for the specific patient.

FIG. 14 provides an exemplary screen shot illustrating the analysis of answers, the assignment of risk scores, and the identification of triggers, in an example of the present invention.

### DETAILED DESCRIPTION

As required, detailed embodiments of the present invention are disclosed herein; however, it is to be understood that the disclosed embodiments are merely exemplary of the invention that may be embodied in various forms. The figures are not necessarily to scale, and some features may be exaggerated to show details of particular components. Therefore, specific structural and functional details disclosed herein are not to be interpreted as limiting, but merely as a basis for the claims and as a representative basis for teaching one skilled in the art to variously employ the present invention.

Unless defined otherwise, all technical and scientific terms used herein have the same meaning as is commonly understood by one of ordinary skill in the art to which this disclosure belongs. In the event that there is a plurality of definitions for a term herein, those in this section prevail unless stated otherwise.

Where ever the phrase “for example,” “such as,” “including” and the like are used herein, the phrase “and without limitation” is understood to follow unless explicitly stated otherwise. Similarly “an example,” “exemplary” and the like are understood to be non-limiting.

The term “substantially” allows for deviations from the descriptor that don't negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a device having components a, b, and c” means that the device includes at least components a, b and c. Similarly, the phrase: “a method involving steps a, b, and c” means that the method includes at least steps a, b, and c.

A “computer system” as used herein can be any suitable computer system. Those skilled in the art will appreciate that aspects of the exemplary embodiments may be practiced with a variety of computer system configurations including, without limitation, single-processor or multiprocessor computer systems, minicomputers, mainframe computers, computer kiosks, as well as personal computers, hand-held wireless mobile devices, tablet computers, smart glasses and smart watches, microprocessor-based or programmable consumer electronics, each of which can be operatively coupled to one or more associated devices. Importantly, the skilled artisan will appreciate that certain embodiments of the present invention can be practiced on existing computing environments and on computing environments to be developed in the future. Aspects of the exemplary embodiments may also be practiced in distributed computing environments where certain tasks are performed by remote processing devices that are linked through a communications network. In a distributed computing environment, program modules may be located in both local and remote memory storage devices. In some cases, the computer system is linked to a wide area network. In other cases, the computer system is linked to the Internet.

The term “Internet” refers to the wide area network of interconnected computers that provides access to and supports the World Wide Web. The World Wide Web consists of documents, usually encoded in highlighted text markup language (“HTML”) that can be accessed using protocols such as TCP/IP and HTTP. The terms “internet” and “World Wide Web” are intended to encompass the technology as it exists today and as it evolves over time.

The term “input” refers to action by a human being. For example, on a system according to the present invention, a keystroke, a finger stroke, a finger tap, a button press, a mouse click, a word or spoken sound, or any combination thereof, intended to cause the system to do something, is an input. A user input may require one or more gestures, such as, for example, one or two mouse clicks, finger taps, a two-finger pinch or expansion, and the like. The input device converts the human action into an electronic input. Upon receiving the electronic input, the system would perform a desired action, such as, for example, to navigate among various screens or to add desired data to a data field. This can be accomplished according to any suitable protocol. For example, a visual display such as a touchscreen can display a widget such as a dialog box. A finger tap within the dialog box is recorded, and the processor instructs the system to perform an action consistent with the finger tap within the dialog box. In some cases, and input can represent a standard gesture offered by a developer or manufacturer of a device such as Apple, Inc. Consultation with a developer's or manufacturer's human interface guidelines will aid the skilled artisan in selecting suitable inputs, in some cases.

A system or device sending a signal receivable by another system or device (such as a server sending a signal) involves the sending of data via one or more electronic or other means with a reasonable expectation that it will be received. To send a signal can include, for example, initiating a teleconference or one-on-one voice call, a voice mail message, a text message, a video message, or an e-mail message, or a combination of two or more thereof.

The term “non-transitory computer readable storage medium” refers to any suitable non-volatile storage medium. Examples include, but are not limited to, NOR or NAND type flash memory chips, erasable programmable read only memory (EPROM), electrically erasable programmable read only memory (EEPROM), read only memory (ROM), programmable read only memory (PROM), hard disk, magnetic tape, optical drives, CD ROM, DVD ROM, or combinations thereof.

The term “instructions” or “computer executable instructions” refers to instructions in program code, written in any suitable programming language(s) or computer-readable code such as binary code, that cause a system to execute steps embodied in the instructions. In certain cases, computer executable instructions configure a computer system having one or more processors with instructions written in Ruby on Rails, NodeJS, MySQL Community Edition, Express Application Framework, Java, JavaScript, PHP, or jQuery, or combinations thereof. In other cases, vendor-specific programming languages or developer interfaces can be used. For example, Apple provides the iOS/iPhone software development kit to allow drafting computer executable instructions that interface with iPhone hardware. An “application” or “program” means a discrete program of instructions that may or may not reference other programs or libraries of code. Generally, programs and applications include routines, modules, components, data structures, etc., that perform particular tasks or implement particular abstract data types. The languages, data structures, and instructions are not limited, and can be any suitable variety.

As used herein, a “health information assessment tool” is a program or application adapted to cause a computer system to perform a method of the present invention, such as, for example, one or more of: accessing a record for a patient; preparing a unique website interface; preparing a list of questions and providing the list of questions to the unique website interface; choosing in presenting follow-up questions based on answers received to the list of questions; electronically analyzing the answers and follow-up answers received and preparing a report therefor; electronically updating the record; and electronically sending the report to a healthcare facilitator, a healthcare professional, the patient, or a combination of such recipients. The tool can be run on any suitable computer system including a distributed computing environment.

It should be understood that various steps of the inventive methods described herein can be performed in any suitable order. Unless required by the transformative nature of preceding steps, a given step can be performed before, during, after, or a combination thereof, relative to another step in a method.

As used herein, “electronic communication” refers to the action of one module, component, device, or system sending to or receiving data from another module, component, device, or system. Electronic communication can be provided by any suitable means. In some cases, electronic communication occurs within a chip, across a motherboard, by cable, wirelessly, via a cellular network, via the internet, or a combination of the foregoing. “Receiving” and “sending,” as in “receiving a signal,” or “sending digital information,” indicate electronic communication. Any suitable protocol can be used for receiving or sending data. Serial transmission, parallel transmission, and asynchronous or synchronous transmission to ensure data integrity can be used.

A “healthcare facilitator” refers to an organization or a person associated with that organization that provides auxiliary or primary medical services such as, for example, an insurance company, primary care organization, urgent care organization, hospital, rehabilitation facility, nursing home, hospice care facility, or a combination thereof. In some cases, the healthcare facilitator is a vendor of electronic medical record services. In other cases, the healthcare facilitator is a health insurance company. In still other cases, the person associated with the healthcare facilitator is a care management nurse, insurance agent, case manager, social worker, medical records analyst, physician's assistant, or a physician. A “healthcare professional” is a person such as a nurse, physician, physician's assistant, medical technician, care management nurse, insurance agent, case manager, social worker, or medical records analyst. Some embodiments of the present invention provide a health information assessment tool operated by a healthcare facilitator. Other embodiments of the present invention relate to a health information assessment tool accessed by a healthcare professional or a patient, or both. As can be seen from the foregoing, the person associated with the healthcare facilitator is also a healthcare professional. In those embodiments where a healthcare professional interfaces with a healthcare facilitator, it is intended that they are not one and the same person.

A “record” for a patient represents any suitable data structure containing medical information about the patient. The record can be accessed by any suitable protocol for data transfer, such as those known in the art. A record can have any suitable number of fields and can include, for example, one or more fields for a member identification number, Social Security number, name, mailing address, email address, telephone number, age, gender, race, height, weight, body mass index, vaccination history, illness history, injury history, medication history, dietary supplement consumption history, hospitalization history, treatment history, mental health history, family history, employment history, allergies, dietary habits, exercise habits, smoking habits, alcohol consumption habits, and recreational drug use habits.

A “unique website interface” comprises one or more Internet- or network-accessible webpages that allows the display of questions and follow-up questions on the display of a suitable computer system. In some instances, only one or a few related questions are displayed at a time, to maximize user comprehension and minimize the potential for error. When the question or all questions on the screen are addressed, the interface will then display the next question or questions. Optionally, the interface can be configured to display an error message such as contained in a pop-up window indicating that one or more questions have not been answered adequately. In certain embodiments of the present invention, the page or pages of the unique website interface are created dynamically, that is, once a user such as a patient or case manager provides an input launching a program that provides a health information assessment tool. The computer system running the program accesses the patient's record from a computer readable storage, for example, searches the record for any missing information, optionally supplies one or more questions to assess current medical needs (for example, “Are you currently experiencing any pain?”), and dynamically creates the interface to present the questions.

Accordingly, some embodiments of the present invention relate to the dynamic creation of a unique website interface. In certain instances, the unique website interface is prepared by

1) receiving on a computer system a signal requesting access to a health information assessment tool;
2) initiating a health information assessment tool on the computer system;
3) accessing with the computer system a website creation module and thereby creating a draft website;
4) retrieving from an accessed record one or more items of health information for the patient, using the computer system;
5) assigning, by the computer system, at least one item of health information for the patient to the draft website;
6) assigning, by the computer system, a specific URL to the draft website;
7) making available to the Internet or another networked environment the draft website via the specific URL, thereby preparing the unique website interface. A list of questions can be prepared before, simultaneously, or after the preparation of the unique website interface, and the list of questions is merged with, added to, or otherwise provided to the unique website interface. Optionally, to comply with HIPAA (“Health Insurance Portability and Accountability Act” law and regulations) and other patient-confidentiality requirements and good practices, the unique website interface is encrypted and password restricted.

Lists of questions can be prepared by any suitable manner. In some cases, electronically preparing the list of questions for the patient comprises electronically selecting questions from a question database based on information in the patient's record. That can occur according to any suitable protocol. For example, the list of questions for the patient can be prepared by the processor accessing a questions database in the memory or computer-readable storage media, and logic applied to select the most useful questions. If the patient is over a certain age, for example, aging-related questions can be selected. If the patient has a diagnosed disease state or illness condition, questions specific to that state or condition can be selected. In another example, the computer system searches the record, and asks questions for any missing information such as, for example, one or more of a member identification number, Social Security number, name, mailing address, email address, telephone number, age, gender, race, height, weight, body mass index, vaccination history, illness history, injury history, medication history, dietary supplement consumption history, hospitalization history, treatment history, mental health history, family history, employment history, allergies, dietary habits, exercise habits, smoking habits, alcohol consumption habits, and recreational drug use habits. In other cases, a healthcare professional can select and customize the questions in the question database. The questions are then electronically transmitted, if necessary, and stored in an accessible manner so the unique website interface can call up the questions and display them for the user. In further instances of the present invention, providing the list of questions to the unique website interface comprises adapting the list to display a first question to the patient, receive a first answer to the first question, and then display a second question to the patient.

A link to the unique website interface is communicated electronically or otherwise to the patient, such as for example by the sending of an email message containing the URL to the unique website interface. For another example, sending an electronic message comprises electronically sending an email message, text message, instant message, or facsimile message. Depending on whether the user will address the questions immediately or at some unknown time in the future, the system may await user input answering the questions. Once the user begins answering the questions presented on the interface, the computer system will receive from the patient electronic input answering questions from the list of questions. When that happens, the computer system will be configured to electronically choose and present follow-up questions on the unique website interface. In certain cases, electronically choosing and presenting follow-up questions comprises selecting follow-up questions from a follow-up question database. That can happen, for example, when the list of follow-up questions for the patient is prepared by the processor accessing a follow-up questions database in the memory or computer-readable storage media. Again, electronic inputs from the user will reflect answers to the follow-up questions.

Analyzing the answers and follow-up answers can proceed according to any suitable method. In some cases, the computer system running the health information assessment tool program will electronically assign one or more risk scores to one or more of the answers and one or more of the follow-up answers. For example, electronically assigning one or more risk scores comprises comparing an answer to a plurality of possible answers, wherein each possible answer in the plurality of possible answers comprises a pre-assigned risk score For another example, electronically assigning one or more risk scores comprises:

electronically selecting a first health condition;
electronically assigning a first risk score for the first health condition to an answer;
electronically selecting a second health condition; and
electronically assigning a second risk score for the second health condition to the answer. This protocol can be continued for any desired number of health conditions.

A risk score is a numerical value reflecting the magnitude of the risk a particular answer identifies. For example, if in response to a question relating to the digestive system, a patient inputs an answer indicating mild heartburn, that answer may receive a risk score of 1. If, however, the answer indicates severe and persistent heartburn, that answer may receive a risk score of 2 or 3, because of the relative severity of the symptom and its likely implications for serious disease.

The analysis continues with the electronic assignment of one or more risk stratifications for one or more health conditions based on the risk scores. For example, some cases of the present invention relate to one or more risk stratifications being based on summing one or more risk scores assigned to one or more of the answers, one or more of the follow-up answers, or a combination thereof. In such a case, the risk scores are added for certain health conditions. It is possible that one question impacts more than one disease state or illness condition. Moreover, it is possible that the same answer to a question may be scored differently for different health conditions. For example, having a body mass index of 30 kg/m² may be scored a “2” for diabetes, and a “1” for heart disease.

Risk stratifications represent two or more categories of relatively greater or lesser health risk. For example, it can be predetermined and customizable for the facilitator to select different numerical thresholds for different health risks. If a patient scores below a threshold, that patient is assigned a lower risk stratification; if the patient scores above a certain threshold, that patient is assigned a higher risk stratification. For example, it can be decided that patients scoring below 5 have “low” risk; those scoring 5 to 9 are assigned “medium” risk; and those scoring 10 or above are assigned “high” risk, for the relevant disease state or illness condition.

“Triggers,” as used herein, are statements for further action primarily directed toward the healthcare facilitator and/or healthcare professional. For example, an overnight hospitalization of a patient within the last six months can be cause for a trigger to appear in the report, reminding a person viewing the report that the patient may need follow up examination or care. Electronically identifying one or more triggers from the record, the answers, and the follow-up answers can proceed according to any suitable protocol. Electronically identifying one or more triggers, for example, may comprise electronically searching the patient's record, the answers, and the follow-up answers for one or a combination of preselected responses, and when those preselected responses appear, then identifying one or more preselected triggers for the report. A preselected response could comprise, for example, a body mass index either less than or greater than a preselected range for body mass index. A preselected range for body mass index is 18.5 to 25 kg/m², which is generally accepted as a “normal” BMI. For another example, the computer system running a health information assessment tool can compare the data fields in the record, the answers, and the follow-up answers against a library of triggers, and be prompted to create or add to an array of identified triggers when a trigger is identified. Sometimes, a single item of information does not by itself compel a trigger, but a combination of information does. For example, in certain instances, a combination of preselected responses comprises smoking habits, alcohol consumption habits, and recreational drug use habits. The computer system can then be prompted by the tool to identify one or more triggers relating to substance abuse rehabilitation and addiction assessment and treatment in the report, and/or prepare one or more follow-up questions and present the follow-up questions to the unique website interface to obtain more information from the patient about the answers that compelled the trigger.

“Electronically preparing a report” can proceed according to any suitable protocol. In certain instances, an electronic data structure is prepared in the memory of or on a computer readable storage device accessible by the computer system, and the one or more risk stratifications and the one or more triggers are assigned to fields within that electronic data structure. Optionally, any additional desired information populates one or more additional fields in the electronic data structure representing the report.

The computer system running the health information assessment tool can electronically update the record with the answers, follow-up answers, and the report according to any suitable protocol. For example, data fields within the record can be filled in with new information if such fields were previously empty. Other data fields can be updated with more recent information obtained by the tool. The updated record can be saved to computer readable storage media, and made accessible for future reference.

The computer system running the tool can send the report to the healthcare facilitator, optionally the patient, and optionally one or more additional healthcare professionals, in any suitable manner. In some cases, the data fields of the report are arranged in a human-readable format that is optionally customizable; the report is printed in any suitable format such as PDF or in a web-browser readable format; and the report is attached to an email message addressed and sent to the desired recipients. Or, the email message itself can contain the text of the report, in some instances. In still other instances, one or more of the answers, the follow-up answers, the risk scores, the risk stratifications, the triggers, the report, and optionally the record itself, can be stored in an Internet- or network-accessible manner, for convenient access by the healthcare facilitator, optionally the patient, and optionally one or more healthcare professionals. Certain instances provide a web browser-readable report such as in HTML format; other instances provide a format such as PDF that can be read by various applications in addition to web browsers. In further instances, sending the electronic message comprises electronically sending an email message, text message, instant message, or facsimile message. In other instances, an electronic message can be sent indicating the report is stored in an Internet- or network accessible location, without containing or attaching the report itself. As used herein, an Internet- or network accessible location means a computer readable storage device that is linked to the Internet or to a network, and is accessible via the Internet and/or a network to one or more of a healthcare facilitator, a patient, and a healthcare professional. In some cases, the Internet- or network accessible location is a server; in other cases, the Internet- or network accessible location is the “cloud.” In still other cases, that location is nearby, such as on a server in the same building; further cases provide that location being remote. Still further cases provide a distribution across more than one location, yet the data can be coherently viewed or assembled by appropriate computer-executable instructions.

Another aspect of the present invention provides one or more of the answers, the follow-up answers, the risk scores, the risk stratifications, and the triggers, the report, and optionally the record itself, viewable through a web portal. In some cases, the web portal is provided by the healthcare facilitator, and is password protected and/or encrypted. In other cases, the portal is provided by the healthcare professional such as the patient's primary care physician, or by a third party vendor such as an electronic medical record service company. A link to the web portal can be communicated to select users by any suitable means, such as, for example, by sending an electronic message to the select users.

Further embodiments of the present invention involve a healthcare facilitator asking a patient or other health-care provider to access and engage a health information assessment tool. It may take some time before the patient or healthcare provider can comply. However, the healthcare facilitator would want to know when the report is ready as soon as possible once it is prepared. Therefore, in some embodiments, the health information assessment tool will alert the healthcare facilitator that the report is ready. In addition to providing the report to the healthcare facilitator, such as for example, by an email message, a separate signal can be sent, such as an instant message, text message, separate email message, automated voicemail message, or any other suitable message that would alert the healthcare facilitator. In certain instances, the healthcare facilitator is alerted by displaying on a visual display an electronic message. In other instances, the healthcare facilitator is alerted by an audible signal, such as a “beep” on the facilitator's computer system such as a smart phone.

It is contemplated that a wide variety of users can employ a health information assessment tool as described herein. In some cases, the healthcare facilitator is an insurance company, primary care organization, urgent care organization, hospital, rehabilitation facility, nursing home, hospice care facility, or a combination thereof. For example, a case manager or disease management nurse employed by a health insurance company or a physician's office can use the tool to follow up with a patient who has used healthcare services within the past year or six months. In this way, the healthcare facilitator can proactively and efficiently assess the needs of the patient and recommend further treatment such as preventative measures or schedule a convenient appointment with an appropriate healthcare provider before the patient emergently and belatedly seeks more expensive care such as in an emergency room.

It is also contemplated that the various embodiments of the invention can be implemented in any suitable fashion. In some cases, a health information assessment tool will represent a stand-alone program or application that a healthcare facilitator accesses independent of any other program or application. In other cases, the health information assessment tool will be seamlessly integrated into another program or application, so that the healthcare facilitator or other healthcare professional can smoothly accomplish a number of tasks. For example, Applicant's health information assessment tool can be integrated into a diagnostic tool, an electronic health record tool, a health insurance policy creation tool, a healthcare billing tool, a patient registration system, a patient management system, or any other application where a guided interview may be helpful or desirable. In that case, once the information is gathered, one or more of the answers, the follow-up answers, the risk scores, the risk stratifications, the triggers, the report, and optionally the record itself, can be made available to the program or application into which the tool is integrated, and/or can be viewed through an Internet- or network-accessible portal. Or, the tool can be configured to provide a report as described above, while other tasks of the program or application can be accomplished.

### DETAILED DESCRIPTION OF THE DRAWINGS

Further embodiments of the present invention can be described by reference to the accompanying drawings.

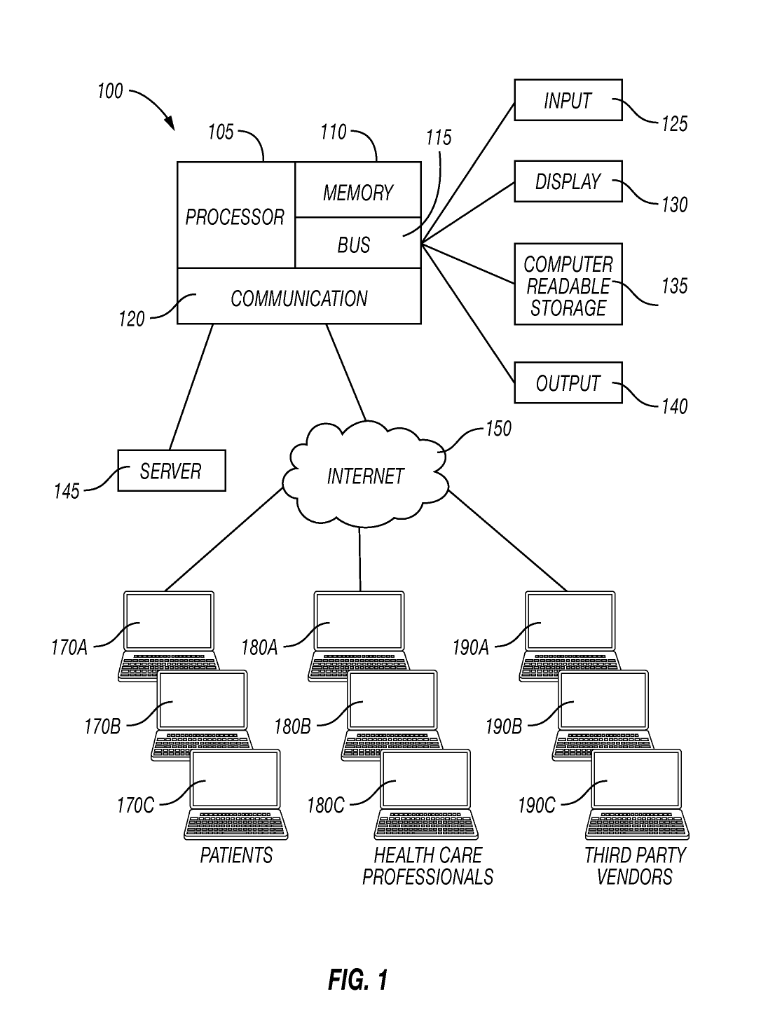

FIG. 1 schematically depicts one embodiment of the invention comprising a computer system 100 useful for storing, assessing, and analyzing patient information. Computer system 100 includes a processor 105, system memory 110, and a communication device 120, each of which are coupled by a system bus 115. The processor 105 may include one or more suitable processors, such as those that are commercially available. System memory 110 includes read-only memory (ROM), random access memory (RAM), or both. A basic input/output system (BIOS) may be stored in a non-volatile memory such as ROM, EPROM, EEPROM, which BIOS contains the basic routines that help to transfer information between components within the computer system 100, such as during start-up. The RAM may also include a high-speed RAM such as static RAM for caching data. The system bus 115 may contain any of several types of bus structure that may be further interconnected to a memory bus, with or without a memory controller, a peripheral bus, and a local bus using any of a variety of bus architectures including those commercially available. The communication device 120 connects computer system 100 to one or more networks such as the Internet 150, and optionally one or more other computer systems, such as a server 145. Via the Internet 150 or any other suitable networked environment, computer system 100 can communicate electronically with any number of patients' computer systems 170A, 170B, 170C; any number of healthcare professionals' computer systems 180A, 180B, 180C; and any number of third-party vendors' computer systems 190A, 190B, 190C. Third-party vendors include but are not limited to medical laboratories, rehabilitation facilities, insurance companies, hospitals, clinics, other software companies, and the like.

The system bus 115 connects the computer system 100 to at least one suitable input device 125. Such devices can be wired or wireless, and include, for example, a keyboard, a pointing device such as a mouse, a microphone functioning in association with language recognition software, a remote control, a joystick, a touchscreen, or the like. A display 130 may also be connected to the system bus 115. The display 130 can include a monitor or, when the input device 125 is a touchscreen, the input device 125 and the display 130 are one and the same.

The system bus 115 may also connect to one or more computer readable storage devices 135. Computer readable storage devices 135 may be any available media that can be accessed by the computer and includes both volatile and nonvolatile media, removable and non-removable media. Computer readable storage devices 135 include generally any method or technology for storage of information such as computer readable instructions, data structures, program modules or other data. Computer readable storage devices 135 include, without limitation, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which may be used to store the desired information and which may be accessed by the computer system 100, such as zip drives and flash memory cards.

The computer system 100 may further comprise at least one output device 140 coupled to the system bus 115. Suitable output devices 140 include, but are not limited to, one or more speakers and one or more printers communicatively coupled to the system bus 115.

The computer readable storage device(s) 135 may store a number of program modules, including for example an operating system, one or more application programs, other program modules and program data. All or portions of the operating system, applications, modules, and/or data may also be cached in the RAM. It is to be appreciated that the exemplary embodiments may be implemented with various commercially available operating systems or combinations of operating systems.

Generally, program modules include routines, programs, components, data structures, etc., that perform particular tasks or implement particular abstract data types. Moreover, those skilled in the art will appreciate that aspects of the exemplary embodiments may be practiced with other computer system configurations including, without limitation, single-processor or multiprocessor computer systems, minicomputers, mainframe computers, as well as personal computers, hand-held wireless computing devices, microprocessor-based or programmable consumer electronics, each of which can be operatively coupled to one or more associated devices. Aspects of the exemplary embodiments may also be practiced in distributed computing environments where certain tasks are performed by remote processing devices that are linked through a communications network. In a distributed computing environment, program modules may be located in both local and remote memory storage devices.

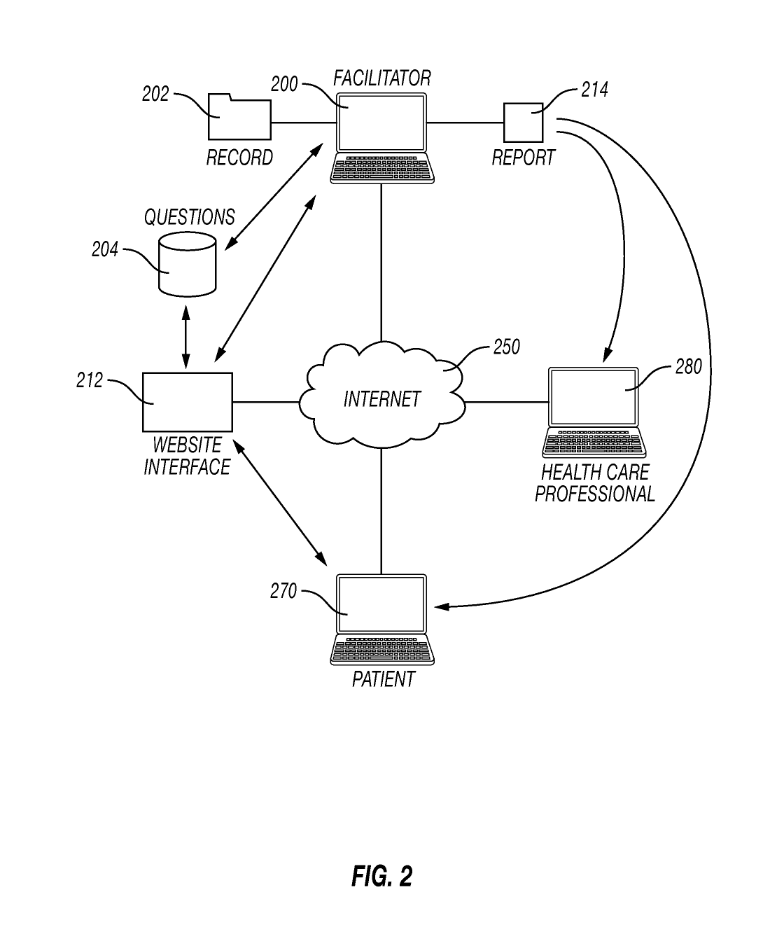

FIG. 2 schematically depicts another embodiment in which a patient's computer system 270 accesses a unique website interface 212 to provide health-related information. For some reason, such as in response to a calendar prompt, a healthcare facilitator such as a care management nurse at a health insurance company decides to assess the patient for medical information. To do so, for example, the facilitator runs a suitable program on the facilitator's computer system 200 to access a record 202 for the patient. The computer system 200 can be any suitable computer system, such as for example the computer system 100 depicted in FIG. 1. The computer system 200 then prepares a unique website interface 212 for the patient, and prepares a list of questions for the patient that appears on the unique website interface 212. The unique website interface 212 can reside in any suitable location, such as a server maintained by the healthcare facilitator or on a server maintained by a website hosting vendor that is accessible via the Internet 250. The computer system 200 constructs the list of questions from a question database 204. Either or both of the patient's record 202 and the question database 204 can reside on the computer system 200 or on another computer system with which the facilitator's computer system 200 is in electronic communication. In this embodiment, the patient's record 202 and the question database 204 reside on the facilitator's computer system 200.

Once the unique website interface 212 is ready, the healthcare facilitator's computer system 200 sends a signal such as an email message containing a URL link to the unique website interface 212 via the Internet 250. That signal or email message is received by the patient on computer system 270. The patient uses a suitable web browser to access the unique website interface 212 via the Internet 250, which access can be controlled with encryption, a password, and any other suitable security technology and techniques. The patient inputs answers to the questions from the list of questions on the patient's computer system 270, and the computer system 200 hosting the unique website interface 212 receives electronic input answering those questions via the Internet 250. The computer system 200 running the program electronically chooses and presents follow-up questions on the unique website interface 212, in some instances in real time, in other instances while the patient is still answering other questions. The computer system 200 accesses the question database 204 to access a follow-up question database contained therein. The follow-up questions are chosen based on the answers provided by the patient. The patient inputs follow-up answers to the follow-up questions on the patient's computer system 270, and the computer system 200 receives electronic input representing those follow-up answers. Optionally, more than one round of follow-up questions can be presented and answered.

At any suitable time, while or after the answers and follow-up answers are arriving for example, the facilitator's computer system 200 begins analyzing the answers and follow-up answers. The computer system 200 electronically assigns one or more risk scores to one or more of the answers and to one or more of the follow-up answers. The computer system 200 electronically assigns one or more risk stratifications for one or more health conditions based on the sum of two or more of the risk scores. The computer system 200 electronically identifies one or more triggers from the information in the patient's record, the answers, and the follow-up answers. Then, the facilitator's computer system 200 electronically prepares a report 214 of one or more of the risk stratifications assigned and one or more of the triggers identified. That report can take any suitable form or file format, such as, for example, a hardcopy report printed out on the healthcare facilitator's printer, or an electronic file in PDF or other suitable format. Also, the facilitator's computer system 200 updates the patient's record 202 with the answers, follow-up answers, risk stratifications, and triggers. The computer system 200 sends an electronic signal such as an email message forwarding a copy of the report 214 to one or more healthcare professionals, which is received, opened, and read on a healthcare professional's computer system 280. Optionally, the computer system 200 also sends an electronic signal such as an email message forwarding a copy of the report 214 to the patient, which is received, opened, and read on the patient's computer system 270. Also, the report 214 can be sent to one or more third party vendors such as medical laboratories and rehabilitation facilities (not shown), if necessary.

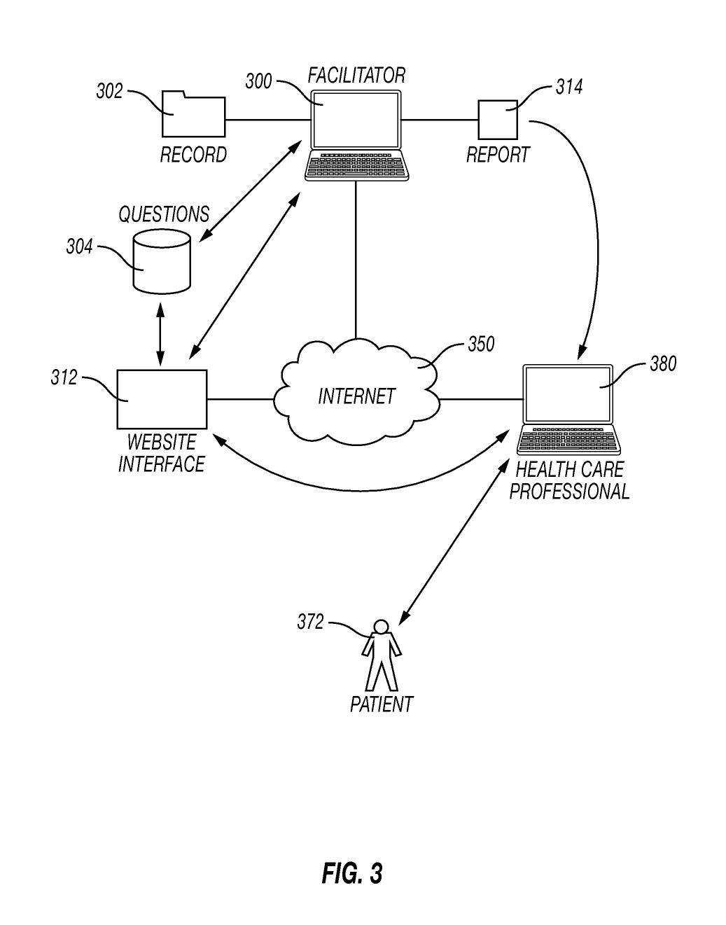

FIG. 3 schematically depicts an embodiment in which a healthcare professional's computer system 380 accesses a unique website interface 312 to assess a patient's 372 health-related information. In this embodiment, the healthcare professional such as a nurse in a hospital or primary care practice accesses a health information assessment tool provided by a healthcare facilitator such as a health insurance company or electronic health record vendor. The nurse and the patient 372 together prompt the healthcare facilitator's computer system 300 to launch the health information assessment tool program by sending a signal such as an email message or clicking on a link pre-supplied by the facilitator to the nurse, using the healthcare professional's computer system 380. Optionally, computer system 380 is a desktop, laptop, kiosk computer, tablet computer or the like, and the nurse launches the tool and has the patient 372 enter responses. Or, the nurse enters the responses in computer system 380, and is speaking with the patient 372 in person or by telephone.

Once prompted, the facilitator's computer system 300 runs a suitable program and accesses a record 302 for the patient. The computer system 300 prepares a unique website interface 312 for the patient, and prepares a list of questions for the patient that appears on the unique website interface 312. The computer system 300 constructs the list of questions from a question database 304. In this embodiment, the patient's record 302 and the question database 304 reside on the facilitator's computer system 300.

Once the unique website interface 312 is ready, the healthcare facilitator's computer system 300 sends a signal via the Internet 350 directing the nurse's computer system 380 to access the unique website interface 312. The patient accesses the unique website interface 312 via the Internet 350, which access can be controlled with encryption, a password, and any other suitable security technology and techniques. The patient or the nurse inputs answers to the questions from the list of questions on the nurse's computer system 380, and the computer system 300 hosting the unique website interface 312 receives electronic input answering those questions via the Internet 350. The computer system 300 running the program electronically chooses and presents follow-up questions on the unique website interface 312, in some instances in real time, in other instances while the patient is still answering other questions. The follow-up questions are chosen based on the answers provided by the patient. The patient or the nurse inputs follow-up answers to the follow-up questions on the nurse's computer system 380, and the computer system 300 receives electronic input representing those follow-up answers via the Internet 350. Optionally, more than one round of follow-up questions can be presented and answered.

At any suitable time, while or after the answers and follow-up answers are arriving for example, the facilitator's computer system 300 begins analyzing the answers and follow-up answers. The computer system 300 electronically assigns one or more risk scores to one or more of the answers and to one or more of the follow-up answers. The computer system 300 electronically assigns one or more risk stratifications for one or more health conditions based on the sum of two or more of the risk scores. The computer system 300 electronically identifies one or more triggers from the information in the patient's record, the answers, and the follow-up answers. Then, the facilitator's computer system 300 electronically prepares a report 314 of one or more of the risk stratifications assigned and one or more of the triggers identified. The facilitator's computer system 300 updates the patient's record 302 with the answers, follow-up answers, risk stratifications, and triggers. The computer system 300 sends an electronic signal such as an email message forwarding a copy of the report 314 to the nurse, which is received, opened, and read the nurse's computer system 380.

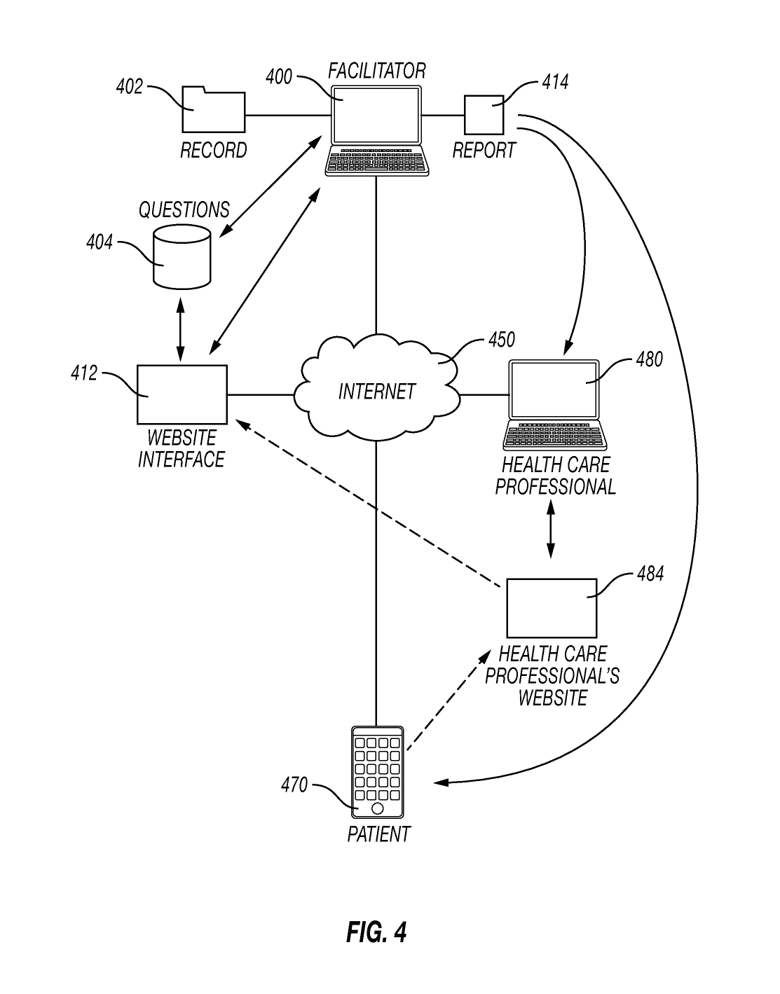

In FIG. 4 a patient seeks an appointment or other service with a healthcare professional, such as his regular doctor. Using his own smart phone 470, the patient accesses his doctor's website 484, which resides on the healthcare professional's computer system 480 that also hosts the doctor's appointment-making program, and is accessible via the Internet 450. A link appears on the doctor's website 484 to a health information assessment tool provided by a healthcare facilitator such as an insurance company or electronic medical record vendor. The patient clicking on the link to the tool sends a signal to the facilitator's computer system 400, which launches a program to implement the tool.

First, the facilitator's computer system 400 accesses a record 402 for the patient. The computer system 400 then prepares a unique website interface 412 for the patient, and prepares a list of questions for the patient that appears on the unique website interface 412. The computer system 400 constructs the list of questions from a question database 404. The patient's record 402 can reside on the computer system 400 or on another computer system with which the facilitator's computer system 400 is in electronic communication, such as, for example, the doctor's computer system 480.

Once the unique website interface 412 is ready, the healthcare facilitator's computer system 400 sends a signal via the Internet 250 to redirect the patient's smart phone 470 to the unique website interface 412. The patient inputs answers to the questions from the list of questions on the patient's smart phone 470, and the computer system 400 receives electronic input answering those questions via the Internet 450. The computer system 400 running the program electronically chooses and presents follow-up questions on the unique website interface 412, in some instances in real time, in other instances while the patient is still answering other questions. The follow-up questions are chosen based on the answers provided by the patient. The patient inputs follow-up answers to the follow-up questions on the patient's smart phone 470, and the computer system 400 receives electronic input representing those follow-up answers. Optionally, more than one round of follow-up questions can be presented and answered.

At any suitable time, while or after the answers and follow-up answers are arriving for example, the facilitator's computer system 400 begins analyzing the answers and follow-up answers. The computer system 400 electronically assigns one or more risk scores to one or more of the answers and to one or more of the follow-up answers. The computer system 400 electronically assigns one or more risk stratifications for one or more health conditions based on the sum of two or more of the risk scores. The computer system 400 electronically identifies one or more triggers from the information in the patient's record, the answers, and the follow-up answers. Then, the facilitator's computer system 400 electronically prepares a report 414 of one or more of the risk stratifications assigned and one or more of the triggers identified. Also, the facilitator's computer system 400 updates the patient's record 402 with the answers, follow-up answers, risk stratifications, and triggers. The computer system 400 sends an electronic signal such as an email message forwarding a copy of the report 414 to the doctor, which is received, opened, and read on the doctor's computer system 480. Optionally, the computer system 400 also sends an electronic signal such as an email message forwarding a copy of the report 414 to the patient, which is received, opened, and read on the patient's smart phone 470. Also, the report 414 can be sent to one or more third party vendors if necessary, such as, for example, to a medical laboratory if the patient needs to schedule a blood draw or other test prior to his appointment with his doctor.

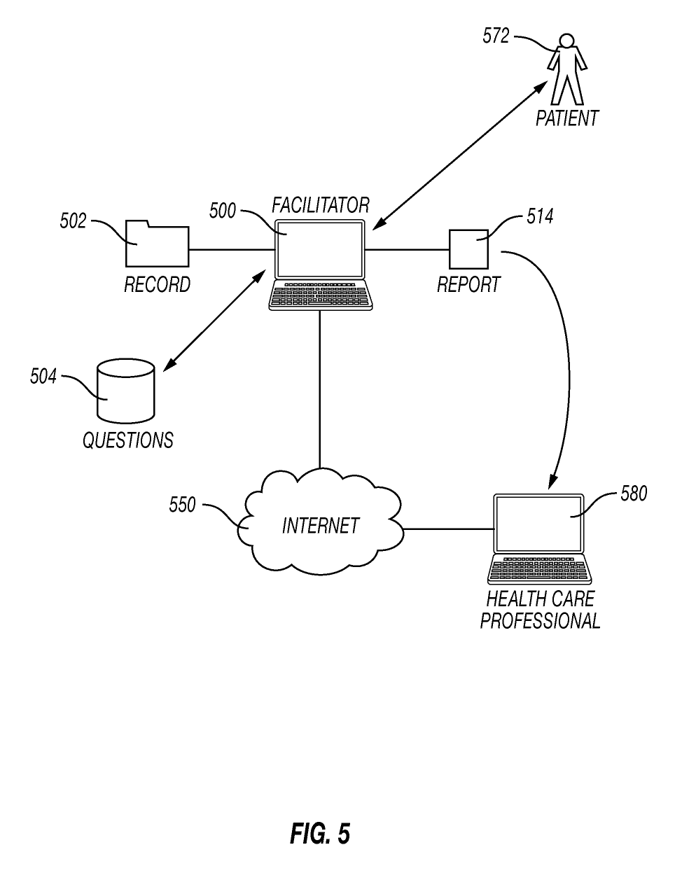

FIG. 5 schematically depicts an embodiment in which a healthcare facilitator's computer system 500 is used to assist a patient 572 to use a health information assessment tool. Here, for example, a care management nurse calls or meets with a patient 572 and employs a health information assessment tool such as a program running on a healthcare facilitator's computer system 500. The computer system launches the program and accesses a record 502 for the patient. The computer system 500 then prepares a list of questions for the patient 572 from a question database 504. Either or both of the patient's record 502 and the question database 504 can reside on the computer system 500 or on another computer system with which the facilitator's computer system 500 is in electronic communication. The computer system 500 displays the questions for the nurse and/or the patient 572.

The nurse or optionally if present the patient 572 inputs answers to the questions from the list of questions on the computer system 500. The computer system 500 running the program electronically chooses and presents follow-up questions for the patient 572, in some instances in real time, in other instances while the patient 572 is still answering other questions. Question database 504 also contains a follow-up question database. The follow-up questions are chosen based on the answers provided by the patient 572. The nurse or the patient inputs follow-up answers to the follow-up questions on the computer system 500, and the computer system 500 receives electronic input representing those follow-up answers. Optionally, more than one round of follow-up questions can be presented and answered.

At any suitable time, while or after the answers and follow-up answers are arriving for example, the facilitator's computer system 500 begins analyzing the answers and follow-up answers. The computer system 500 electronically assigns one or more risk scores to one or more of the answers and to one or more of the follow-up answers. The computer system 500 electronically assigns one or more risk stratifications for one or more health conditions based on the sum of two or more of the risk scores. The computer system 500 electronically identifies one or more triggers from the information in the patient's record, the answers, and the follow-up answers. Then, the facilitator's computer system 500 electronically prepares a report 514 of one or more of the risk stratifications assigned and one or more of the triggers identified. That report 514 can take any suitable form or file format, such as, for example, a hardcopy report printed out on the healthcare facilitator's printer, or an electronic file in PDF or other suitable format. Also, the facilitator's computer system 500 updates the patient's record 502 with the answers, follow-up answers, risk stratifications, and triggers. The computer system 500 sends an electronic signal such as an email message forwarding a copy of the report 514 to one or more healthcare professionals via the Internet 550, which is received, opened, and read on a healthcare professional's computer system 580.

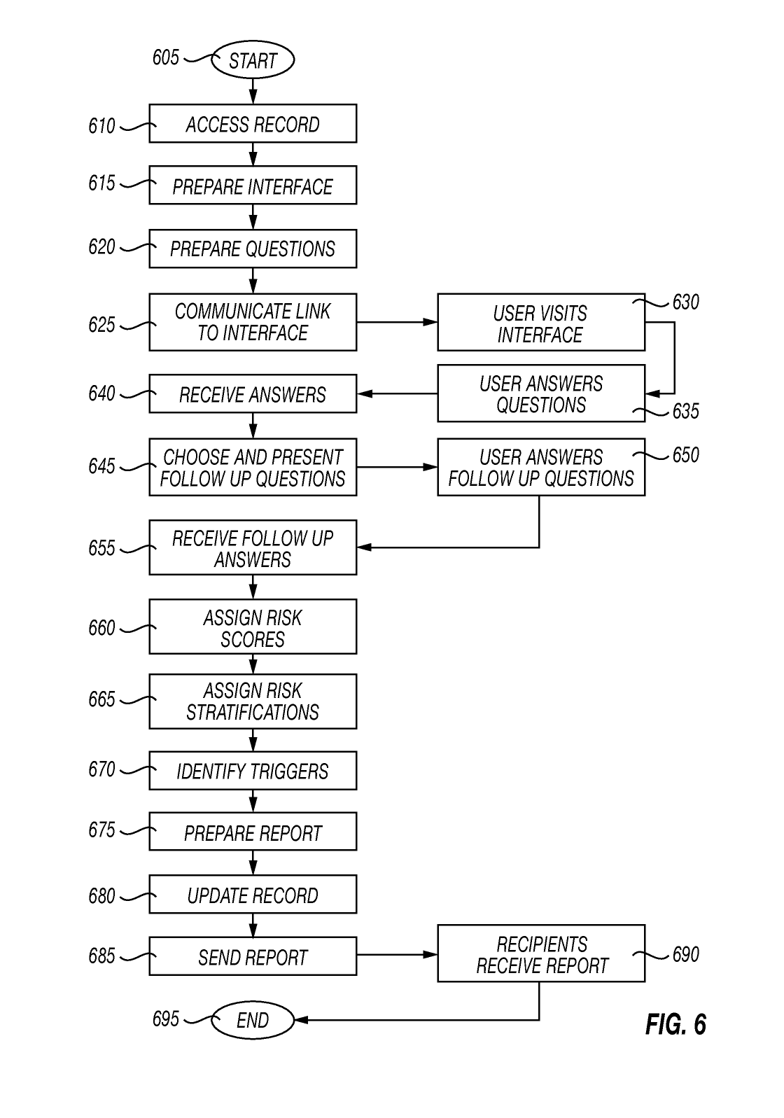

FIG. 6 provides a flowchart illustrating a method of assessing a patient for medical information and preparing a report thereof. A suitable computer system operated by a healthcare facilitator, such the computer system 100 described in FIG. 1, runs a software program providing a health information assessment tool. At the start 605, the computer system accesses 610 a record for the patient and prepares 615 a unique website interface for the patient. The computer system then prepares 620 a list of questions for the patient, and provides the list of questions to the unique website interface. The system then communicates 625 a link to the unique website interface to a user such as a care management nurse, other healthcare professional, and the patient, which can take the form of, for example, an email message. The user visits 630 the unique website interface, and answers 635 questions by inputting responses into the user's computer system. The facilitator's computer system receives 640 the patient's electronic input answering questions from the list of questions, and electronically chooses and presents 645 follow-up questions on the unique website interface. Via the Internet, the user's computer system allows the user to answer 650 the follow-up questions by inputting responses into the user's computer system. The facilitator's computer system receives 655 the follow-up answers, in the form of the patient's electronic input. The facilitator's computer system then analyzes the answers and follow-up answers by assigning 660 one or more risk scores to the answers and follow-up answers, summing the risk scores for certain diseases and conditions, and assigning 665 risk stratifications based on the sum of those risk scores. The facilitator's computer system then electronically identifies one or more triggers based on the information in the patient's record, the answers, and the follow-up answers. The computer system then electronically prepares 675 a report of the risk stratifications assigned and the triggers identified and electronically updates 680 the patient's record. The system electronically sends 685 the report to the healthcare facilitator, optionally the patient, and optionally one or more additional healthcare professionals. Those recipients receive 690 the report electronically, and the process ends 695. In some cases, electronically sending 685 the report to the healthcare facilitator comprises alerting a nurse or other employee of the healthcare facilitator that the report has been prepared and is awaiting review.

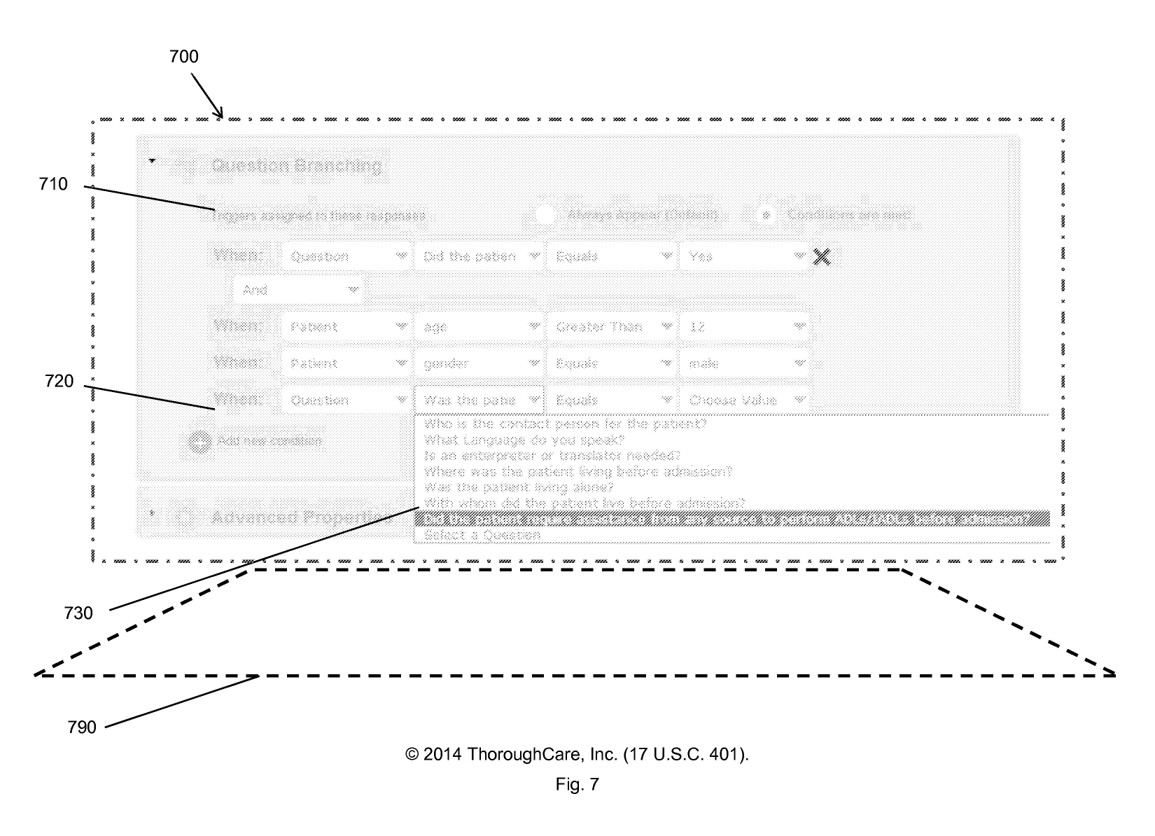

An understanding of FIGS. 7-14 can be gained with reference to the examples that follow.

### EXAMPLES

### Example 1

### Customizing a Health Information Assessment Tool

FIG. 7 shows an exemplary screenshot of a question branching dialogue 700. In this screenshot, shown on schematically-represented laptop 790, a healthcare professional is selecting a combination of answers to questions that will represent a trigger. On line 710, triggers are assigned to the identified conditions when all conditions are met. Line 720 illustrates a drop-down menu 730 allowing the healthcare professional designing the list of questions to select the condition desired for this trigger.

Further examples of questions, follow-up questions, and triggers that could be employed in a health information assessment tool according to the present invention follow:

### Questions and Follow-Up Questions Examples

The following question is asked of a diabetic patient, the status of being a diabetic patient having been determined from an analysis of the patient's record, for example:
Are you able to obtain all needed supplies to take the insulin or other injectable hypoglycemic as the provider has recommended?
The following follow-up question would be asked only if the previous question is answered “no”.
Which of the supplies or medications are you having difficulty obtaining?
The following follow-up question would be asked only if the previous question is answered “Insulin Pens”.
Which of the following are the main reason(s) you can't obtain the needed Insulin Pens?
A series of follow-up questions relating to, “Pediatric Diabetes”, is asked only if the patient's age is 12 years or less.
A series of follow-up questions relating to, “Women's Health”, is asked only if the patient's gender is female.

### Risk Stratification Examples

The diabetic patient is asked this question:
Are you able to obtain all needed supplies to take the insulin or other injectable hypoglycemic as the provider has recommended?
If “Yes” is answered, a risk score of 0 is generated.
If “No” is answered, a risk score of 5 is generated.
A risk stratification for the series of questions and follow-up questions relating to diabetes is assigned as follows: 0-2 is Low Risk—Patient Likely Compliant and Stable; 3-4 is Medium Risk—Monitor; 5+ is Risky—Needs Attention. Because a diabetic patient without access to the minimum complement of medical supplies needed for safe management of blood glucose faces considerable risk, a negative answer to that one question immediately identifies that patient as facing unacceptable risk and needing immediate attention. Such immediate attention could prevent costly or even fatal outcomes. Answers with risk scores above 0 can signal the need for follow-up questions to thoroughly assess the nature of the patient's risk.

### Trigger Examples

If the following question is answered with “No” . . . .
“Has all needed equipment been ordered for timely delivery to the patient's home?” The following Trigger is automatically generated:
“Care alert: Post discharge prescribed medical equipment may not be available on a timely basis.”
This Trigger would alert the healthcare facilitator or healthcare professional of an appropriate “outcome” and “next step” that should be addressed.
If the following question is answered with “No” . . . .
“Is the patient or their caregiver able to state the purpose of each of the medications?” The following Trigger is automatically generated:
“Potential discharge educational need: Patient/caregiver unable to state purpose of discharge medications.”
This Trigger would alert the user of an appropriate “outcome” and “next step” that should be addressed.

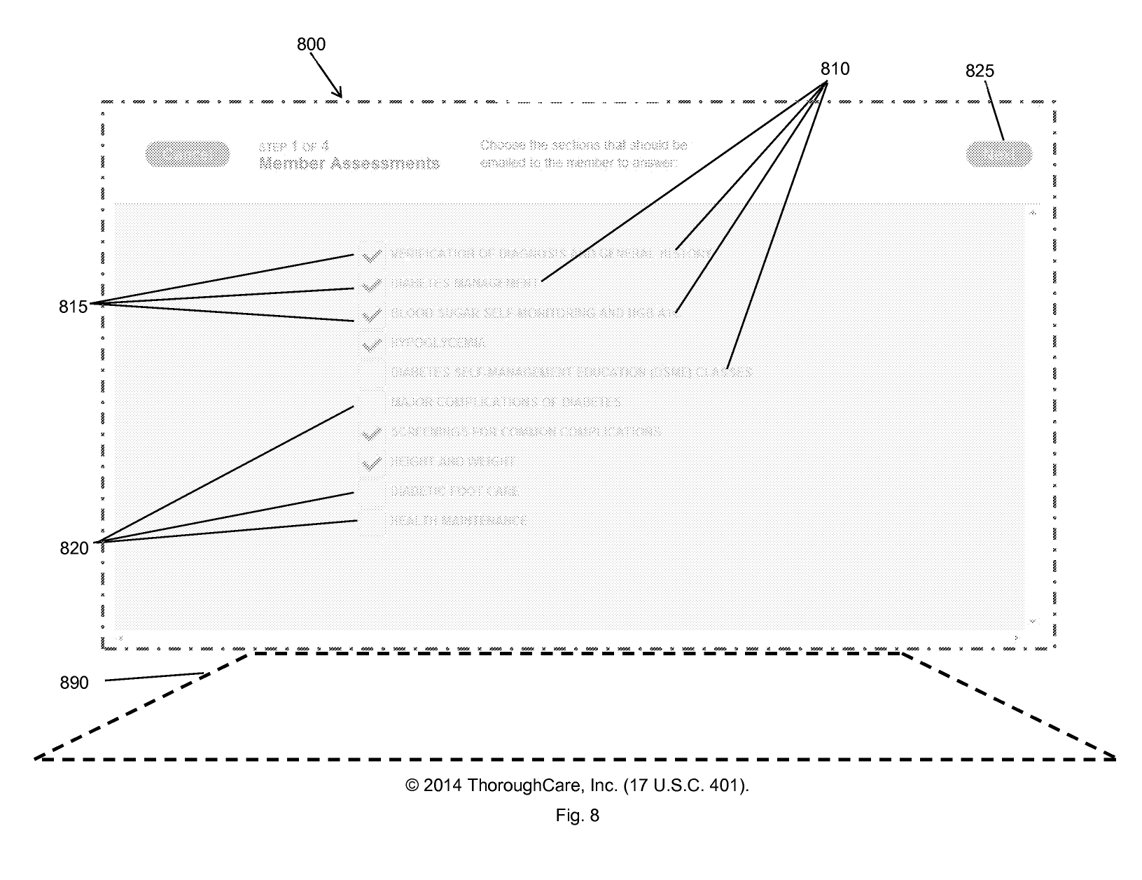

FIG. 8 provides an exemplary screenshot of a section selection dialogue 800 on schematically-represented laptop 890. Here, a user of a health information assessment tool in accordance with an embodiment of the present invention can select which sections of related questions from the list of questions will be presented to the patient on the unique website interface. Sections 810 appear listed on the section selection dialogue 800, wherein each section 810 includes questions from the list of questions generated for the patient. The user inputs a signal such as a mouse click on those check boxes 815 indicating sections 810 to be presented to the patient. Unchecked check boxes 820 indicate which sections 810 of questions from the list of questions that will not be presented to the patient. When the navigation button 825 is selected, such as by a mouse click input by the user, the selected sections 810 with the checked checkboxes 815 are provided to the unique website interface. Accordingly, certain embodiments of the present invention relate to preparing a unique website interface for the patient; preparing a list of questions for the patient, and providing a subset of the list of questions to the unique website interface.

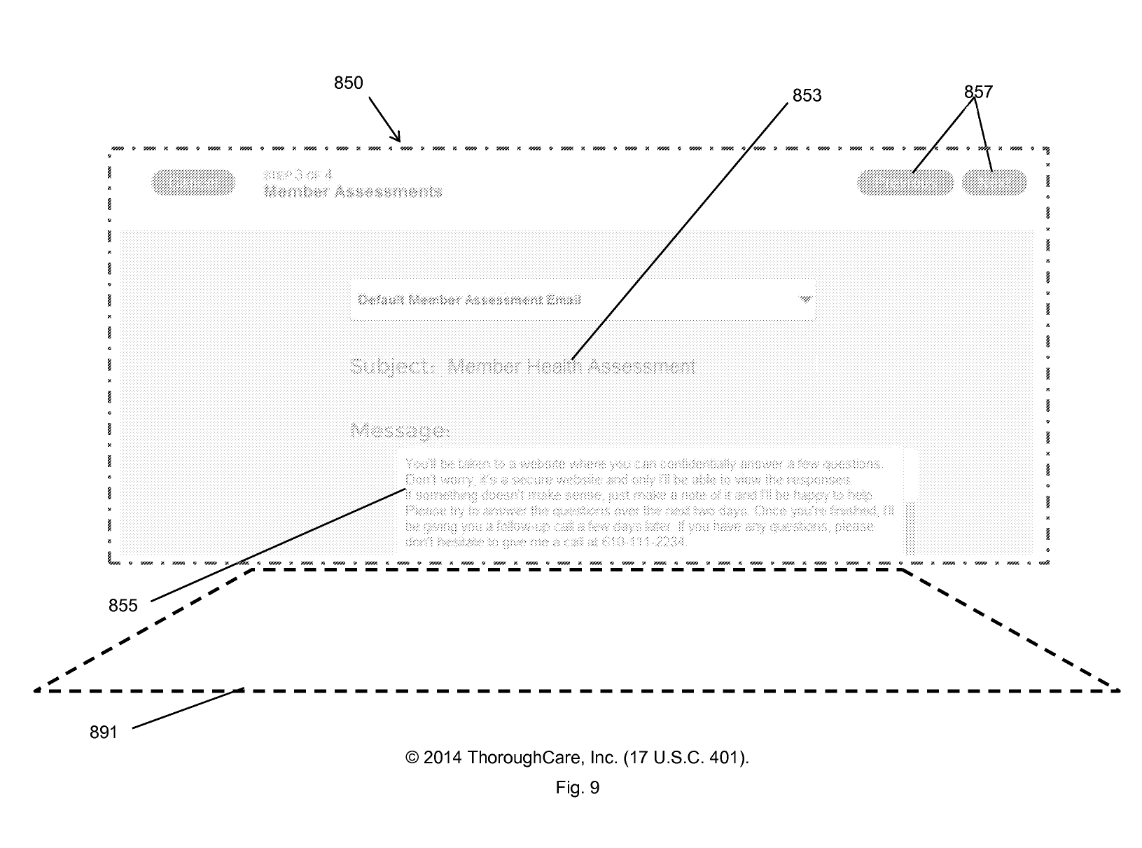

FIG. 9 provides an exemplary screenshot of an email message design dialogue 850, depicted on schematically-represented laptop 891, that allows the healthcare professional customizing the health information assessment tool to edit the email message that will be sent inviting the patient to access the unique website interface. Line 853 allows the user to edit the subject line of the email message, and the body of the email message can be edited using window 855. Navigation buttons 857 allow the user to return to a previous dialogue screen, or to confirm and send the email message to the patient.

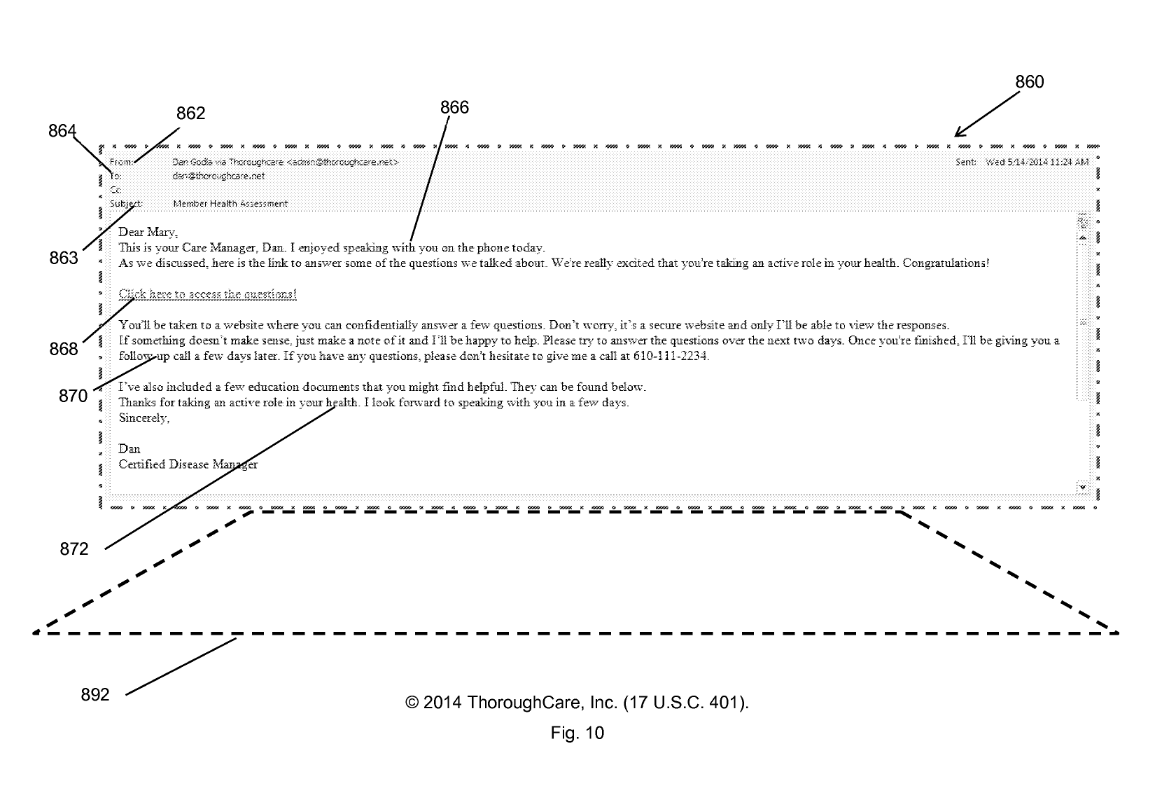

FIG. 10 shows an exemplary and fictitious e-mail message 860 from a healthcare facilitator, specifically, a certified disease manager, to a patient, communicating a link to the unique website interface. Ficticious e-mail message 860 appears on schematically-represented personal computer 892. Line 862 shows the email address of the user such as a healthcare facilitator or healthcare professional that is inviting the patient to use the health care information tool. Line 864 normally contains the email address of the patient. Line 863 contains the subject of the email message, which can be edited on line 853 in FIG. 9. The body 866 of the email message is editable in the window 855 in FIG. 9. The link to the unique website interface is hyperlinked to line 868 of the email message 860. The URL can appear spelled out in cut-and-pastable form, in some embodiments, or it can be omitted, as in this email message 860. Paragraph 870 appeared in window 855 of FIG. 9. Paragraph 872 shows that the email message 860 communicating a link to the unique website interface can contain any suitable additional information, such as documents that may educate the patient about her health and her treatment.

### Example 2

### Using the Health Information Assessment Tool

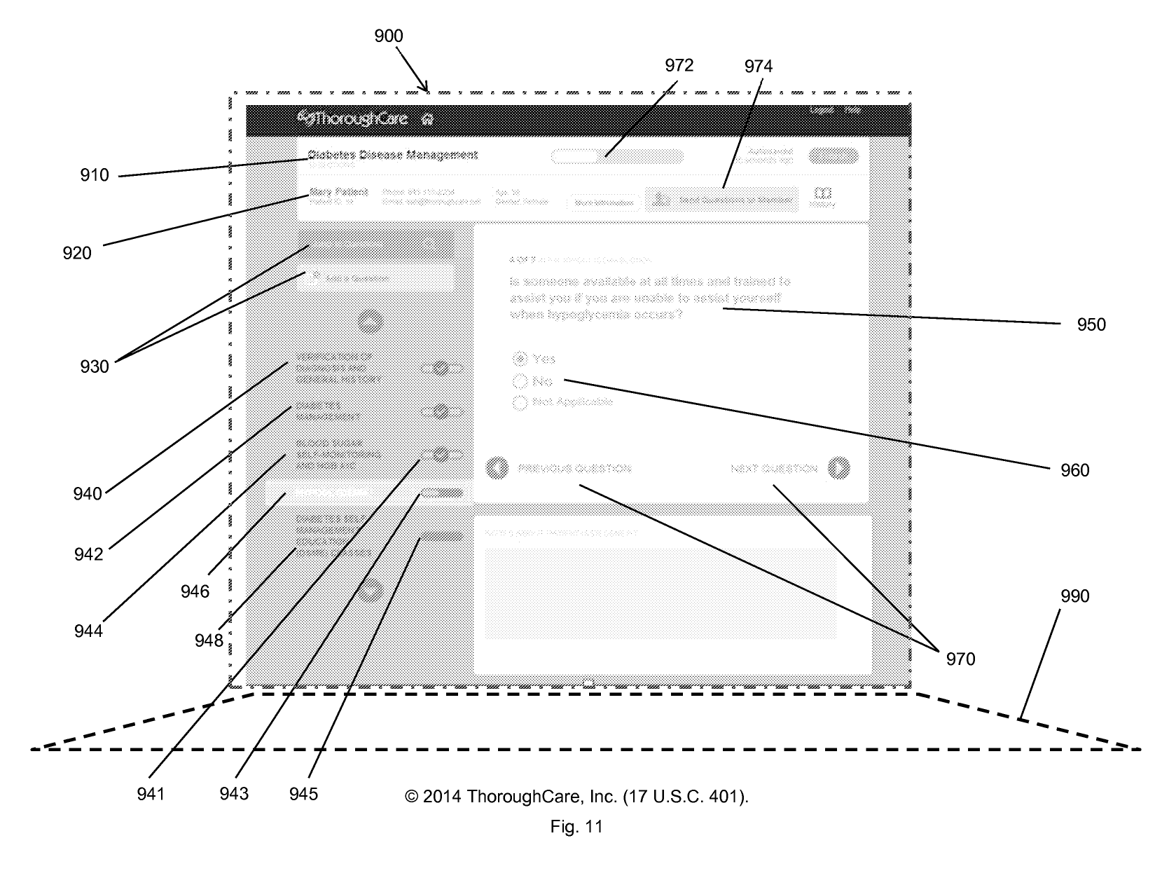

FIG. 11 illustrates an exemplary question screen 900 for a health information assessment tool in accordance with one embodiment of the invention. This embodiment of the tool would involve a healthcare facilitator or healthcare professional accessing the unique website interface while consulting with a patient for answers, for example on schematically-represented laptop computer 990. Question screen 900 shows for a disease area 910 that the question is assessing diabetes disease management. Line 920 identifies the patient by name, unique identifying number, phone number, email address, age, and gender. Buttons 930 allow a user such as a healthcare facilitator or healthcare professional answering the list of questions in consultation with the patient to navigate through the list and to add additional questions; those buttons can be inactivated or hidden in embodiments answered by the patient. For example, if the patient tells the facilitator that the patient experienced chest pain recently while the facilitator is addressing questions relating to diabetes, the facilitator can jump to questions relating to chest pain and cardiac health or add a question about the chest pain to appear later in the patient interview, with buttons 930. Sections 940, 942, 944, 946, and 948 illustrate the progress through several sections of the list of questions relating to diabetes disease management. Section 940, for example, entitled, “Verification of Diagnosis and General History,” confirms the patient suffers from diabetes and explores the patient's medical history. Section progress bars 941, 943, and 945 appear next to the title of each section of questions. Section progress bar 941 shows that section 944 is complete; section progress bar 943 shows that section 946 is almost halfway complete; and section progress bar 945 shows that section 948 has not been addressed at all. Question 950 of section 946 is presented in a straightforward manner, enabling the user such as a healthcare facilitator or healthcare provider to focus on the question and to enter an answer in area 960. Line 970 allows the user to navigate from question to question for greater ease of use. Overall progress bar 972 indicates the list of questions has just begun, and button 974 allows the user to send select questions or even entire sections of questions from the list of questions to the patient.

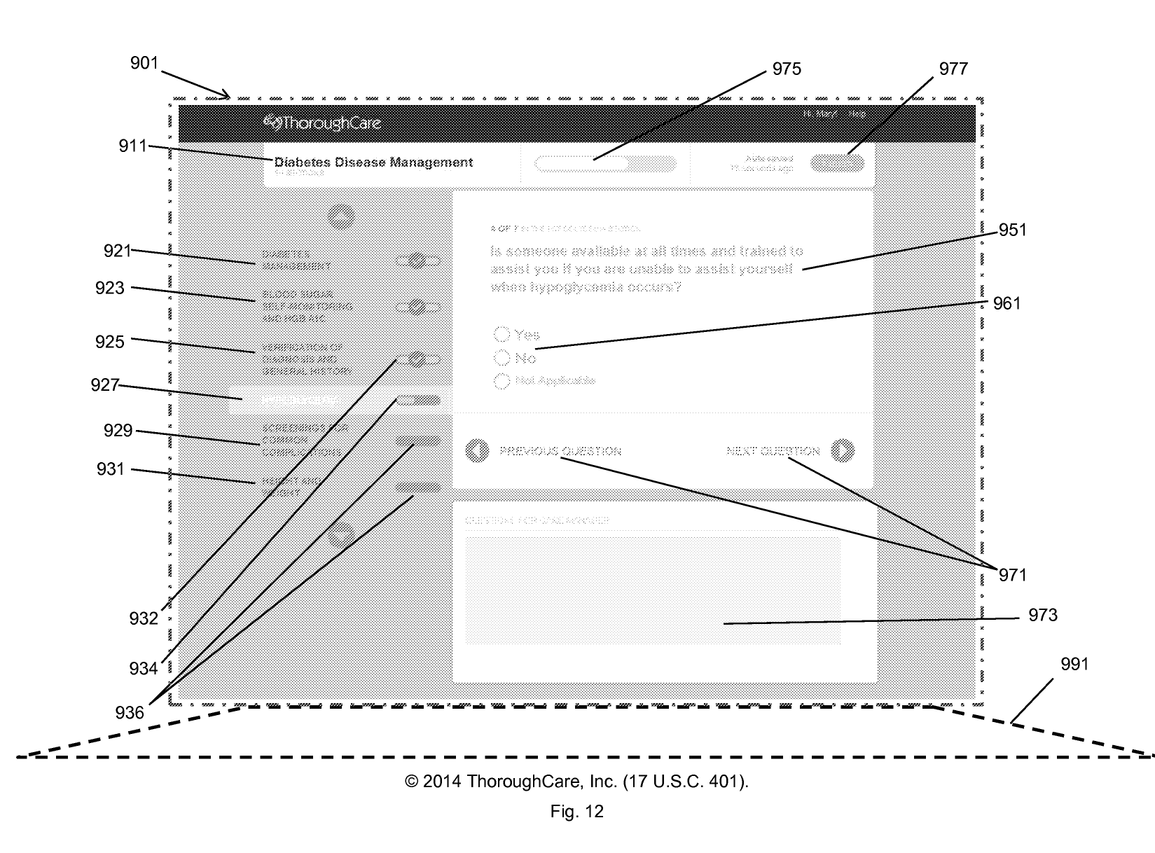

FIG. 12 illustrates an exemplary question screen 901 for a health information assessment tool in accordance with one embodiment of the invention. This embodiment of the tool would involve a patient accessing the unique website interface to provide answers to questions, for example on schematically-represented kiosk workstation 991. Question screen 901 shows for a disease area 911 that the question is assessing diabetes disease management. Sections 921, 923, 925, 927, 929, and 931 illustrate the progress through several sections of the list of questions relating to diabetes disease management. Section 925, for example, entitled, “Verification of Diagnosis and General History,” confirms the patient suffers from diabetes and explores the patient's medical history. Section progress bars 932, 934, and 936 appear next to the title of each section of questions. Section progress bar 932 shows that section 925 is complete; section progress bar 934 shows that section 927 is almost halfway complete; and section progress bars 936 show that sections 929 and 931 have not been addressed at all. Question 951 of section 927 is presented in a straightforward manner, enabling the patient to focus on the question and to enter an answer in area 961. Line 971 allows the patient to navigate from question to question for greater ease of use. Window 973 allows the patient to send, in an email message or instant message for example, an inquiry from within the tool itself. Overall progress bar 975 indicates the list of questions has just begun, and button 977 allows the patient to log off of the unique website interface, when or before all questions have been answered.

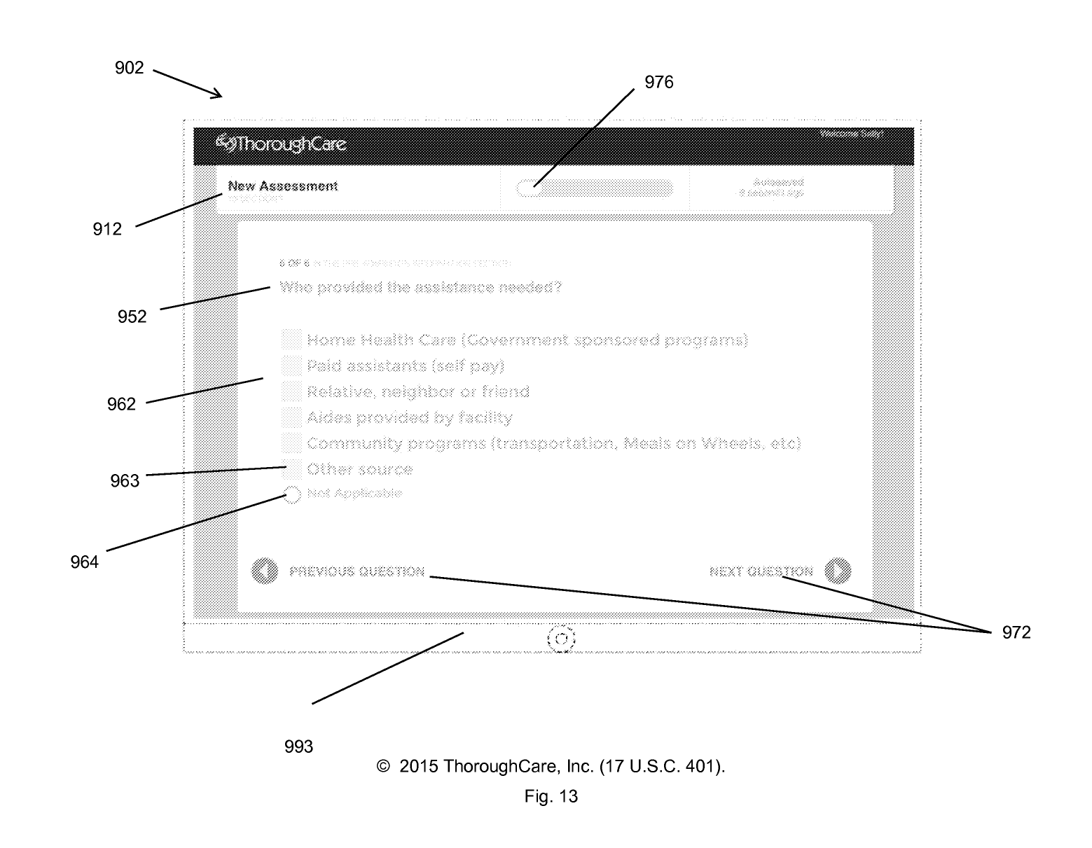

FIG. 13 illustrates an exemplary question screen 902 for a health information assessment tool in accordance with another embodiment of the invention. This embodiment of the tool would involve a patient accessing the unique website interface via tablet computer 993 to provide answers to questions. Question screen 902 shows for this tablet-based embodiment information area 912 that question 952 relates to a new assessment. Question 952 seeks detailed information on the provider of previous medical assistance, and is presented as a follow-up to an affirmative answer to a previous question (not shown) asking whether previous medical assistance was required. The patient can select a relevant answer in area 962. Optionally, one or more of the answers in area 962 can trigger one or more follow-up questions, optionally presented in the form of a follow-up screen. For example, selecting answer 963 can be configured to open up a new screen offering a text box, into which the user can type relevant information. Answer 964 indicates that needed assistance was not obtained, and can also lead to a new screen offering follow-up questions or a text box seeking further explanation. Overall progress bar 976 indicates the assessment is just beginning. Line 972 allows the patient to navigate from question to question for greater ease of use.

### Example 3

### Analysis, Assignment of Risk Scores, and Identification of Triggers

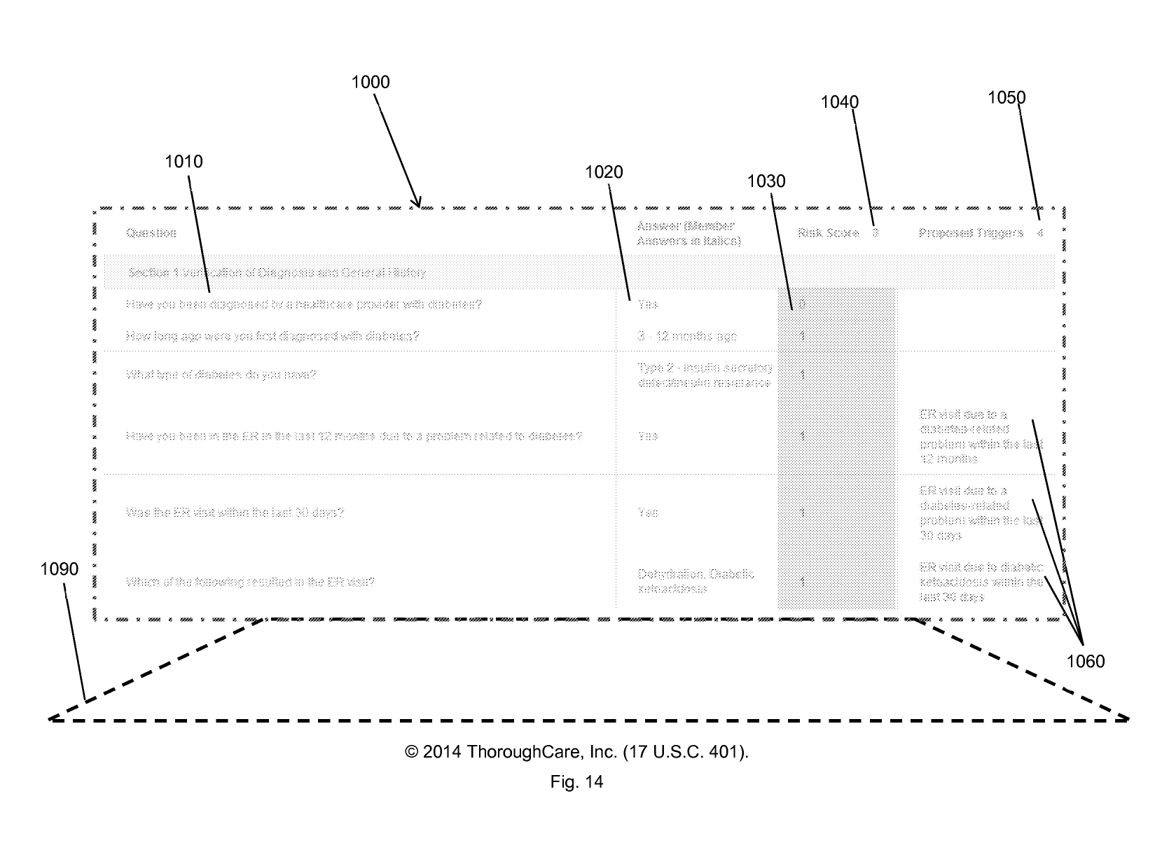

FIG. 14 illustrates an exemplary analysis screen 1000 of a list of questions 1010 and the corresponding answers 1020, depicted on schematically-represented personal computer 1090. Risk scores 1030 are selectively assigned to the answers and a risk score total 1040 appears. Here, the risk score total 1040 is “8,” which can be used to assign a risk stratification to the patient with respect to the patient's diabetes. Also, triggers 1060 in the screenshot, and the total number of triggers 1050 appear as well. The risk score total 1040, used to assign a risk stratification, and the identified triggers 1060 would appear in a report provided to the healthcare facilitator, healthcare professional, patient, or two or more thereof, so that further treatment can be selected and implemented. When a health information assessment tool obtains data such as that shown in FIG. 14, and presents that data in the form of a concise report to a healthcare professional or a healthcare facilitator, the diabetes of the patient can be managed better.

As previously stated, detailed embodiments of the present invention are disclosed herein; however, it is to be understood that the disclosed embodiments are merely exemplary of the invention that may be embodied in various forms. It will be appreciated that many modifications and other variations stand within the intended scope of this invention as claimed below. Furthermore, the foregoing description of various embodiments does not necessarily imply exclusion. For example, “some” embodiments may include all or part of “other” and “further” embodiments within the scope of this invention. In addition, “a” does not mean “one and only one;” “a” can mean “one and more than one.”

I claim:

1. A method for assessing a patient for medical information and preparing a report thereof via the Internet, the method comprising:
A. Accessing, on a computer system operated by a healthcare facilitator, a record for the patient;
B. Preparing a unique website interface for the patient;
C. Preparing a list of questions for the patient, and providing the list of questions to the unique website interface;
D. Communicating a link to the unique website interface to the patient;
E. Receiving from the patient electronic input answering questions from the list of questions;
F. Electronically choosing and presenting follow-up questions on the unique website interface;
G. Receiving from the patient electronic input providing follow-up answers to the follow-up questions;
H. Electronically assigning one or more risk scores to one or more of the answers and one or more of the follow-up answers;
I. Electronically assigning one or more risk stratifications for one or more health conditions based on the sum of two or more of the risk scores;
J. Electronically identifying one or more triggers from the record, the answers, and the follow-up answers;
K. Electronically preparing a report of the one or more risk stratifications and the one or more triggers;
L. Electronically updating the record with the answers, follow-up answers, and the report; and
M. Electronically sending the report to the healthcare facilitator, optionally the patient, and optionally one or more additional healthcare professionals.

2. The method of claim 1 wherein the healthcare facilitator is an insurance company, primary care organization, urgent care organization, hospital, rehabilitation facility, nursing home, hospice care facility, or a combination thereof.

3. The method of claim 1, wherein the unique website interface is encrypted and password restricted.

4. The method of claim 1, wherein the preparing a list of questions for the patient comprises electronically selecting questions from a question database based on information in the patient's record.

5. The method of claim 4, wherein the information comprises one or more of a member identification number, Social Security number, name, mailing address, email address, telephone number, age, gender, race, height, weight, body mass index, vaccination history, illness history, injury history, medication history, dietary supplement consumption history, hospitalization history, treatment history, mental health history, family history, employment history, allergies, dietary habits, exercise habits, smoking habits, alcohol consumption habits, and recreational drug use habits.

6. The method of claim 1, wherein providing the list of questions to the unique website interface comprises adapting the list to display a first question to the patient, receive a first answer to the first question, and then display a second question to the patient.

7. The method of claim 1, wherein communicating a link comprises sending an electronic message comprising the URL of the unique website interface.

8. The method of claim 7, wherein sending an electronic message comprises electronically sending an email message, text message, instant message, or facsimile message.

9. The method of claim 1, wherein the electronically choosing and presenting follow-up questions comprises selecting follow-up questions from a follow-up question database.

10. The method of claim 1, wherein the electronically assigning one or more risk scores comprises comparing an answer to a plurality of possible answers, wherein each possible answer in the plurality of possible answers comprises a pre-assigned risk score.

11. The method of claim 1, wherein the electronically assigning one or more risk scores comprises:
electronically selecting a first health condition;
electronically assigning a first risk score for the first health condition to an answer;
electronically selecting a second health condition; and
electronically assigning a second risk score for the second health condition to the answer.

12. The method of claim 1, wherein the electronically identifying one or more triggers comprises electronically searching the record for the patient, the answers, and the follow-up answers for one or a combination of preselected responses.

13. The method of claim 12, wherein a preselected response comprises a body mass index either less than or greater than a preselected range for body mass index.

14. The method of claim 13, wherein the preselected range for body mass index is 18.5 to 25 kg/m².

15. The method of claim 12, wherein a combination of preselected responses comprises smoking habits, alcohol consumption habits, and recreational drug use habits.

16. The method of claim 1, wherein the electronically sending the report comprises sending an electronic message containing the report.

17. The method of claim 16, wherein sending the electronic message comprises electronically sending an email message, text message, instant message, or facsimile message.

18. A computer system comprising a processor and memory, the processor operable to execute program code stored in the memory, the program code adapted to cause the processor to
A. Access, in the memory, a record for the patient;
B. Prepare a unique website interface for the patient;
C. Prepare a list of questions for the patient, and provide the list of questions to the unique website interface;
D. Communicate a link to the unique website interface to the patient;
E. Receive from the patient electronic input answering questions from the list of questions;
F. Choose and present follow-up questions on the unique website interface;
G. Receive from the patient electronic input providing follow-up answers to the follow-up questions;
H. Assign one or more risk scores to one or more of the answers and one or more of the follow-up answers;
I. Assign one or more risk stratifications for one or more health conditions based on the sum of two or more of the risk scores;
J. Identify one or more triggers from the record, the answers, and the follow-up answers;
K. Prepare a report of the one or more risk stratifications and the one or more triggers;
L. Update the record with the answers, follow-up answers, and the report, and store the report in the memory; and
M. Alert a healthcare facilitator that the report has been prepared.

19. The computer system of claim 18, wherein the list of questions for the patient is prepared by the processor accessing a questions database in the memory.

20. The computer system of claim 18, wherein the list of follow-up questions for the patient is prepared by the processor accessing a follow-up questions database in the memory.

21. The computer system of claim 18, wherein the computer system is linked to a wide area network.

22. The computer system of claim 18, wherein the computer system is linked to the Internet.

23. The computer system of claim 18, wherein the healthcare facilitator is alerted by displaying on a visual display an electronic message.

24. The computer system of claim 18, wherein the healthcare facilitator is alerted by an audible signal.

25. A non-transitory computer readable storage medium comprising program code adapted to cause a computer system to:
A. Access, in the computer system, a record for the patient;
B. Prepare a unique website interface for the patient;
C. Prepare a list of questions for the patient, and provide the list of questions to the unique website interface;
D. Communicate a link to the unique website interface to the patient;
E. Receive from the patient electronic input answering questions from the list of questions;
F. Choose and present follow-up questions on the unique website interface;
G. Receive from the patient electronic input providing follow-up answers to the follow-up questions;
H. Assign one or more risk scores to one or more of the answers and one or more of the follow-up answers;
I. Assign one or more risk stratifications for one or more health conditions based on the sum of two or more of the risk scores;
J. Identify one or more triggers from the record, the answers, and the follow-up answers;
K. Prepare a report of the one or more risk stratifications and the one or more triggers;
L. Update the record with the answers, follow-up answers, and the report, and store the report in the computer system; and
M. Alert a healthcare facilitator that the report has been prepared.

26. A method for assisting a healthcare professional to assess a patient for medical information and prepare a report thereof via the Internet, the method comprising:
A. Accessing via the internet, from a computer system operated by the healthcare professional, a unique website interface for the patient;
B. Receiving a list of questions for the patient on the unique website interface;
C. Accepting inputs on the computer system providing answers to questions from the list of questions;
D. Receiving follow-up questions for the patient on the unique website interface, the follow-up questions being based on the answers;
E. Accepting inputs on the computer system providing follow-up answers to the follow-up questions;
F. Receiving on the computer system a report of one or more risk stratifications and one or more triggers for the patient,
wherein the one or more risk stratifications are based on summing one or more risk scores assigned to one or more of the answers, one or more of the follow-up answers, or a combination thereof;
wherein the one or more triggers have been identified from an electronic analysis of the record, the answers, and the follow-up answers.

27. A method for assisting a patient to provide medical information for a report thereon via the Internet, the method comprising:
A. Receiving a signal via the internet, on a computer system operated by a healthcare facilitator, a request from a computer system operated by the patient, seeking access to a unique website interface for the patient;
B. Presenting, by the computer system operated by the healthcare facilitator, a list of questions for the patient on the unique website interface;
C. Receiving, on the computer system operated by the healthcare facilitator, signals from the computer system operated by the patient, representing answers to questions from the list of questions;
D. Presenting, by the computer system operated by the healthcare facilitator, follow-up questions for the patient on the unique website interface, the follow-up questions being based on the answers;
E. Receiving, on the computer system operated by the healthcare facilitator, signals from the computer system operated by the patient, representing follow-up answers to the follow-up questions;
F. Preparing on the computer system operated by the healthcare facilitator, a report of one or more risk stratifications and one or more triggers for the patient,
wherein the one or more risk stratifications are based on summing one or more risk scores assigned to one or more of the answers, one or more of the follow-up answers, or a combination thereof;
wherein the one or more triggers have been identified from an electronic analysis of the record, the answers, and the follow-up answers.

28. A computer system comprising a processor and memory, the processor operable to execute program code stored in the memory, the program code adapted to cause the processor to
A. Access via the internet a unique website interface for the patient;
B. Receive a list of questions for the patient on the unique website interface;
C. Display questions from the list of questions on a visual display of the computer system;
D. Accept inputs on the computer system providing answers to questions from the list of questions, and provide the answers to the unique website interface;
E. Receive follow-up questions for the patient on the unique website interface, the follow-up questions being based on the answers;
F. Accept inputs on the computer system providing follow-up answers to the follow-up questions, and provide the follow-up answers to the unique website interface;
G. Receive on the computer system a report from the unique website interface of one or more risk stratifications and one or more triggers for the patient,
wherein the one or more risk stratifications are based on summing one or more risk scores assigned to one or more of the answers, one or more of the follow-up answers, or a combination thereof;
wherein the one or more triggers have been identified from an electronic analysis of the record, the answers, and the follow-up answers.

29. A non-transitory computer readable storage medium comprising program code adapted to cause a computer system to:
A. Access via the internet a unique website interface for the patient;
B. Receive a list of questions for the patient on the unique website interface;
C. Display questions from the list of questions on a visual display of the computer system;
D. Accept inputs on the computer system providing answers to questions from the list of questions, and provide the answers to the unique website interface;
E. Receive follow-up questions for the patient on the unique website interface, the follow-up questions being based on the answers;
F. Accept inputs on the computer system providing follow-up answers to the follow-up questions, and provide the follow-up answers to the unique website interface;
G. Receive on the computer system a report from the unique website interface of one or more risk stratifications and one or more triggers for the patient,
wherein the one or more risk stratifications are based on summing one or more risk scores assigned to one or more of the answers, one or more of the follow-up answers, or a combination thereof;
wherein the one or more triggers have been identified from an electronic analysis of the record, the answers, and the follow-up answers.
